(19) United States
(12) Patent Application Publication
(10) Pub. No.: US 2019/0276771 A1
(43) Pub. Date: Sep. 12, 2019

(54) DISHWASHER DETERGENT CONTAINING A COPOLYMER

(71) Applicant: Clariant International Ltd.

(72) Inventors: Hannah BENSON, Bensheim (DE); Mike SAHL, Bad Camberg (DE); Natascha Katharina SCHELERO, Hattersheim (DE); Christine OBERBILLIG (geb. MUELLER), Ginsheim-Gustavsburg (DE)

(73) Assignee: Clariant International Ltd., Muttenz (CH)

(21) Appl. No.: 16/463,818

(22) PCT Filed: Nov. 21, 2017
(86) PCT No.: PCT/EP2017/079939

§ 371 Date: May 23, 2019

(30) Foreign Application Priority Data
Nov. 28, 2016 (DE) 102016223589.3

(51) Int. Cl. C11D 1/835; C11D 11/00; C11D 3/386; C11D 17/00

(52) U.S. Cl. CPC C11D 1/835; C11D 11/0023; C11D 1/74; C11D 17/0091; C11D 3/38609

(57) ABSTRACT

The invention relates to dishwasher detergents which comprise, as component Z1), one or more copolymers containing cationic structural units and macromonomer structural units and, as component Z2), one or more enzymes. The dishwasher detergents have in particular an advantageous rinsing power and an advantageous drying power, in both cases also in phosphate-free compositions.

The present invention relates to dishwasher detergents comprising copolymers (polymer additives) which comprise one or more cationic structural units and one or more macromonomeric structural units, to a method for cleaning dishware in dishwashers with aqueous alkaline compositions comprising a dishwasher detergent of the invention, and also to the use of the dishwasher detergents of the invention or of the copolymers as rinse agents in machine dishwashing, for improving the wettability of dishware, for reducing the spotting and filming on dishware, for improving the rinse performance of a dishwasher detergent, or for improving the drying performance of a dishwasher detergent.

For the purposes of the present invention, the dishwasher detergents of the invention comprehend not only dishwasher detergents in the conventional sense but also rinse agents.

The requirements imposed on machine-washed dishware are nowadays very high, particularly by comparison with manual dishwashing. In addition to residue-free cleaning, the dishware after the complete cleaning program—generally consisting of a prewash cycle, a main wash cycle, followed by a rinse cycle with concluding drying phase, where the individual cycles are interrupted by intermediate cycles—is to be present in a streak-free and spot-free, flawlessly sparkling condition. Even in the case of the flawless elimination of food residues from the dishware, whitish residues attributable to water hardness or other inorganic or organic salts, and spots which originate from dried-on water drops and water films, lead to the wash performance being rated not as flawless. For a long time, therefore, rinse aids have been successfully used for improved rinse performance in rinse agents and dishwasher detergents, in order to obtain spotless, streak-free, and residue-free dishware. In the case of rinse agents, the rinse aid is dispensed automatically from a metering tank into the interior of the dishwasher in the rinse cycle of the cleaning program. In products referred to as multifunctional combination products, the rinse aid is integrated into the dishwasher detergent itself.

Conventional rinse aids are liquid mixtures of low-foaming nonionic surfactants, organic acids such as, for example, citric acid, scale-inhibiting polymers, solvents such as, for example, ethanol, and other additives such as hydrotropes, thickeners and/or foam inhibitors.

Rinse aid formulations are typically liquid at 20° C. and have an acidic pH of 6 or lower. Rinse aids are typically added into the dishwasher during the final rinse cycle of the cleaning program. The function of rinse aids is to influence the interfacial tension of the water in the final rinse cycle in such a way that the water is able to run from the washed surfaces in the form of a thin film, with the result that, during the subsequent drying cycle, no water drops, lime spots, streaks, films or other deposits are left on the cleaned dishware.

The cleaning of dishware in dishwashers, particularly for domestic use, is continually subject to modifications and improvements. For example, new formats of multifunctional combination products (“all-in-one” metering systems) are continually being developed, such as single-phase or multiphase tablets, pouches, pods, and capsules (“caps”), or liquid formats such as multifunctional gels. Such multifunctional combination products require new rinse aid additives which are active against spotting and filming and which exhibit advantageous rinse performance and/or advantageous drying performance while they are present in the overall cleaning operation.

Polymers have long been established in the prior art as active ingredients of detergents, especially of dishwasher detergents. In dishwasher detergents they are used in particular as softeners and/or rinse aid additives. In the prior art, both nonionic and anionic and also cationic or amphoteric polymers have been described for these purposes.

DE 10032612 describes the use of specific copolymers composed of unsaturated carboxylic acids, monomers containing sulfonic acid groups, and, optionally, further ionic or nonionic monomers in dishwasher detergents for improving the rinsing and drying effects.

WO 2007/073801 describes dishwasher detergents which comprise polymers having at least one positive charge and a nonionic surfactant, and also the use of these dishwasher detergents as rinse agents during machine dishwashing.

WO 2005/097963 describes dishwasher detergents which comprise polymers having at least one positive charge and phosphorus-containing complexing agents, and also the use of these dishwasher detergents as rinse agents during machine dishwashing.

WO 2005/075621 describes solid dishwashing detergents which comprise polymers having at least one positive charge, bleaches, and nonionic surfactants, and also the use of these dishwasher detergents for the cleaning and rinsing of glassware.

WO 2012/042001 describes dishwasher detergents which comprise cationic polysaccharides, and the use of these dishwasher detergents for eliminating, reducing or for preventing spots and/or films, especially on glassware.

U.S. Pat. No. 6,239,091 describes dishwasher detergents which comprise water-soluble cationic or amphoteric polymers, and a technique for reducing the spotting and filming on glassware as a result of using these dishwasher detergents.

EP 0077588 describes dishwasher detergents or rinse agents which comprise nonionic surfactants and cationic polyelectrolytes.

Although the rinse results achieved with the systems described in the prior art are already good, there nevertheless remains broad room for improvements to the existing products, particularly in respect of improved rinse performance and/or drying performance of dishwasher detergents.

The object of the present invention was to provide dishwasher detergents which as well as an advantageous cleaning performance also display in particular an advantageous rinse performance and an advantageous drying performance.

Surprisingly it has been found that this object can be achieved by means of dishwasher detergents comprising
Z1) one or more copolymers containing
a) 0.1 to 99.9 mol %, preferably 20.0 to 80.0 mol %, and more preferably 22.0 to 77.6 mol % of one or more cationic structural units (A) and
b) 0.1 to 99.9 mol %, preferably 0.4 to 20.0 mol %, and more preferably 0.5 to 4.4 mol % of one or more macromonomeric structural units (B),
   wherein the one or more cationic structural units (A) are represented by the following formulae (I) and/or (II):

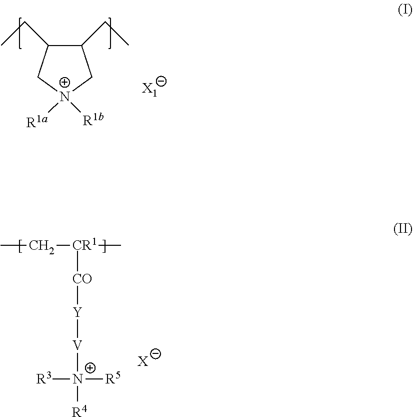

R¹ and R^{1a} are each identical or different and independently of one another are each hydrogen and/or a methyl radical,
R^{1b}, R³, R⁴ and R⁵ are each identical or different and independently of one another are each represented by hydrogen, an aliphatic hydrocarbon radical having 1 to 20, preferably 1 to 4, carbon atoms, a cycloaliphatic hydrocarbon radical having 5 to 20, preferably 5 to 8, carbon atoms, an aryl radical having 6 to 14 carbon atoms and/or polyethylene glycol (PEG), and preferably are each identical or different and independently of one another are each represented by hydrogen and/or methyl, and more preferably are each methyl,
Y is identical or different and is represented by oxygen, NH and/or NR³,
V is identical or different and is represented by —(CH₂)ₓ—,

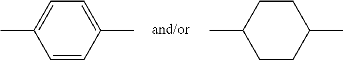

x is identical or different and is represented by an integer from 1 to 6,
X and X₁ are each identical or different and independently of one another are each represented by a halogen atom, C₁ to C₄ alkyl sulfate and/or C₁ to C₄ alkylsulfonate,
   and the one or more macromonomeric structural units (B) are represented by the formula (III):

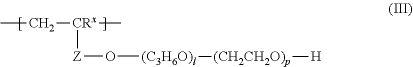

in which
R^{x} is identical or different and is represented by H and/or methyl,
Z is identical or different and is represented by C═O and/or O(CH₂)₄ and is preferably O(CH₂)₄,
l is on molar average a number from 0 to 7 and preferably from 0 to 6, and
p is on molar average a number from 1 to 150, preferably from 11 to 150, and more preferably from 12 to 150
and
Z2) one or more enzymes.

Subject matter of the invention are therefore dishwasher detergents comprising
Z1) one or more copolymers containing
a) 0.1 to 99.9 mol %, preferably 20.0 to 80.0 mol %, and more preferably 22.0 to 77.6 mol % of one or more cationic structural units (A) and
b) 0.1 to 99.9 mol %, preferably 0.4 to 20.0 mol %, and more preferably 0.5 to 4.4 mol % of one or more macromonomeric structural units (B),
   wherein the one or more cationic structural units (A) are represented by the following formulae (I) and/or (II):

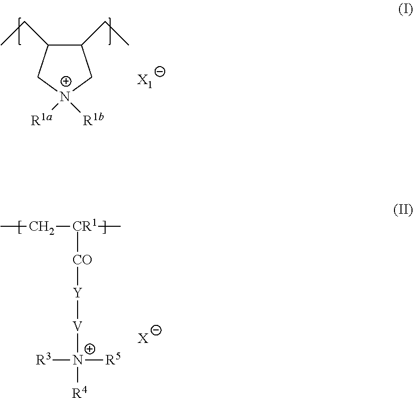

R¹ and R^{1a} are each identical or different and independently of one another are each hydrogen and/or a methyl radical,
R^{1b}, R³, R⁴ and R⁵ are each identical or different and independently of one another are each represented by hydrogen, an aliphatic hydrocarbon radical having 1 to 20, preferably 1 to 4, carbon atoms, a cycloaliphatic hydrocarbon radical having 5 to 20, preferably 5 to 8, carbon atoms, an aryl radical having 6 to 14 carbon atoms and/or polyethylene glycol (PEG), and preferably are each identical or different and independently of one another are each represented by hydrogen and/or methyl, and more preferably are each methyl,
Y is identical or different and is represented by oxygen, NH and/or NR³,
V is identical or different and is represented by —(CH₂)ₓ—,

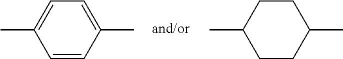

x is identical or different and is represented by an integer from 1 to 6,
X and X₁ are each identical or different and independently of one another are each represented by a halogen atom, C₁ to C₄ alkyl sulfate and/or C₁ to C₄ alkylsulfonate,
   and the one or more macromonomeric structural units (B) are represented by the formula (III):

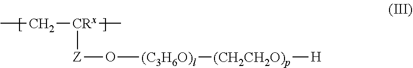

in which
R^{x} is identical or different and is represented by H and/or methyl,
Z is identical or different and is represented by C═O and/or O(CH₂)₄ and is preferably O(CH₂)₄,
l is on molar average a number from 0 to 7 and preferably from 0 to 6, and
p is on molar average a number from 1 to 150, preferably from 11 to 150, and more preferably from 12 to 150
and
Z2) one or more enzymes.

WO 2012/076365 A1 discloses cationic copolymers comprising cationic structural units and macromonomeric structural units, and also their use as admixtures for building material systems, particularly based on calcium sulfate.

WO 2008/049549 A2 describes hydrophobically modified cationic copolymers which have at least three different structural units and of which one structural unit has a terminal phenyl group or specifically substituted phenyl group. The copolymers can be used, particularly in combination with anionic surfactants and even in the event of high salt loads, to achieve a considerable improvement in the water retention in aqueous building material systems based on hydraulic binders, such as cement.

WO 2008/141844 A1 describes dispersions comprising inorganic particles, water, and at least one water-soluble polymer. The at least one water-soluble polymer has repeating units deriving from monomers having at least one quaternary ammonium group, repeating units deriving from monomers having at least one carboxyl group, and repeating units deriving from polyalkoxyalkylene group-containing ester monomers with a number-average molecular weight in the range from 3000 g/mol to 10 000 g/mol. The dispersions can be used especially for producing concrete and can be processed over a very long time.

WO 2008/046652 A1 describes graft polymers obtainable by copolymerizing at least one specific macromonomer and at least one further monomer which has a polymerizable, ethylenically unsaturated double bond, and also describes the use thereof as dispersants, in pigment concentrates, for example.

US 2011/0144264 A1 describes the use of substances such as, for example, polyethylene glycol- or poly(ethylene-co-propylene) glycol-(meth)acrylic esters which are able to contribute to the stabilization during the operation of latex production through emulsion polymerization of at least one polymerizable monomer.

JP 2008-056711 A discloses copolymers which have a number-average molecular weight of 5000 to 1 000 000 and which comprise structural units formed by polymerization of certain cationic monomers, polyoxyalkylene-modified monomers, and crosslinkable monomers, and which may additionally comprise further structural units, formed by polymerization of further monomers which can be copolymerized with the aforementioned monomers. The copolymers can be used, for example, as antistatic agents for thermoplastic polymers.

An advantage of the invention is that the dishwasher detergents of the invention display very good dishware wettability, low spotting and filming on dishware, an advantageous rinse performance, and an advantageous cleaning performance.

The copolymers of component Z1) can be employed both in conventional rinse aids and in conventional and multifunctional combination products, or can be employed with broad variability in the dishwasher detergents of the invention, and develop their advantageous properties independently of their preparation form.

A further advantage of the invention is that the dishwasher detergents of the invention exhibit advantageous drying performance on the dishware items treated with the dishwasher detergent.

The copolymers of component Z1) do not contribute to increased foaming, and accordingly the dishwasher detergents of the invention are low-foaming detergents.

A further advantage of the invention is that the dishwasher detergents of the invention display their advantageous properties, and particularly an advantageous rinse performance, even in phosphate-free compositions.

Preferably the one or more cationic structural units (A) of the one or more copolymers of component Z1) of the dishwasher detergents of the invention represent the polymerization product of at least one monomer species selected from the group consisting of [2-(acryloyloxy)ethyl]trimethylammonium chloride, [2-(acryloylamino)ethyl]trimethylammonium chloride, [2-(acryloyloxy)ethyl]trimethylammonium methosulfate, [2-(methacryl-oyloxy)ethyl]trimethylammonium chloride and methosulfate, [3-(acryloyl-amino)propyl]trimethylammonium chloride, [3-(methacryloylamino)propyl]-trimethylammonium chloride and diallyldimethylammonium chloride (DADMAC); more preferably the one or more cationic structural units (A) of the one or more copolymers of component Z1) of the dishwasher detergents of the invention represent the polymerization product of at least one monomer species selected from the group consisting of [3-(acryloylamino)propyl]trimethylammonium chloride, [3-(methacryloylamino)propyl]trimethylammonium chloride, and diallyldimethylammonium chloride; and especially preferably the one or more cationic structural units (A) of the one or more copolymers of the component Z1) of the dishwasher detergents of the invention represent the polymerization product of at least one monomer species selected from the group consisting of [3-(methacryloylamino)propyl]trimethylammonium chloride and diallyldimethylammonium chloride.

Preferably the one or more macromonomeric structural units (B) of the formula (III) of the one or more copolymers of component Z1) of the dishwasher detergents of the invention represent the polymerization product of at least one monomer species selected from the group consisting of polyethylene glycol vinyloxybutyl ether, polyethylene glycol-co-polypropylene glycol vinyloxybutyl ether (in which l is on molar average a number from 1 to 7, preferably from 2 to 6, and more preferably from 3 to 6), polyethylene glycol (meth)acrylate and polyethylene glycol-co-polypropylene glycol (meth)acrylate (in which l is on molar average a number from 1 to 7, preferably from 2 to 6, and more preferably from 3 to 6).

For the purposes of the present invention, the expression “(meth)acrylate” embraces not only the corresponding acrylate compound but also the corresponding methacrylate compound.

More preferably in the one or more macromonomeric structural units (B) of the formula (III) of the one or more copolymers of component Z1) of the dishwasher detergents of the invention

i) R^{x} is H, l is 0, and p is on molar average a number from 1 to 150, preferably from 11 to 150, and more preferably from 12 to 150 if Z is O(CH₂)₄ or
ii) R^{x} is identical or different and is represented by H and/or methyl, l is on molar average a number from 1 to 7, preferably from 2 to 6, and more preferably from 3 to 6, and p is on molar average a number from 1 to 150, preferably from 11 to 150, and more preferably from 12 to 150 if Z is C═O.

Preferably the one or more copolymers of component Z1) of the dishwasher detergents of the invention comprise not only the structural units (A) and (B) but also one or more structural units (C) which differ from the structural units (A) and (B), the one or more copolymers containing

preferably 0.1 to 99.8 mol % of the one or more structural units (A), 0.1 to 99.8 mol % of the one or more structural units (B), and 0.1 to 99.8 mol % of the one or more structural units (C),
more preferably 20.0 to 80.0 mol % of the one or more structural units (A), 0.4 to 20.0 mol % of the one or more structural units (B), and 15.5 to 74.6 mol % of the one or more structural units (C), and
especially preferably 22.0 to 77.6 mol % of the one or more structural units (A), 0.5 to 4.4 mol % of the one or more structural units (B), and 18.0 to 74.5 mol % of the one or more structural units (C).

More preferably the one or more structural units (C) of the one or more copolymers of component Z1) of the dishwasher detergents of the invention represent the polymerization product of at least one monomer species selected from the group consisting of noncationic acrylamides, noncationic methacrylamides, and N-vinyl-substituted lactams having 5 to 7 ring atoms.

Especially preferably the one or more structural units (C) of the one or more copolymers of component Z1) of the dishwasher detergents of the invention are selected from the group consisting of the polymerization product of at least one N-vinyl-substituted lactam having 5 to 7 ring atoms and structural units of the following formulae (IV) and/or (V):

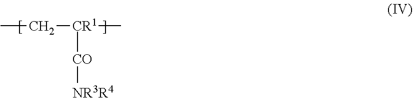

in which
R¹ is identical or different and is hydrogen and/or methyl, and
R³ and R⁴ are each identical or different and independently of one another are each represented by hydrogen, an aliphatic hydrocarbon radical having 1 to 20, preferably 1 to 4, carbon atoms, a cycloaliphatic hydrocarbon radical having 5 to 20, preferably 5 to 8, carbon atoms, an aryl radical having 6 to 14 carbon atoms, an alkylaryl radical having 7 to 14 carbon atoms, a branched or unbranched C₁-C₅ monohydroxyalkyl group and/or polyethylene glycol (PEG)

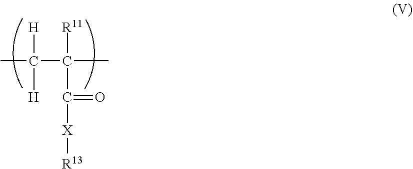

in which
R¹¹ is identical or different and is represented by H and/or methyl;
X is identical or different and is represented by NH—(CₙH₂ₙ) where n=1, 2, 3 or 4; and
R¹³ is identical or different and is represented by OH, N(CH₃)₂, SO₃H, PO₃H₂, O—PO₃H₂ and/or para-substituted C₆H₄—SO₃H.

Among the polymerization product selected from N-vinyl-substituted lactams having 5 to 7 ring atoms, the polymerization product of N-vinylpyrrolidone is preferred.

The SO₃H, PO₃H₂, O—PO₃H₂, and para-substituted C₆H₄—SO₃H groups in the compounds of the formula (V) may also be in salt form, preferably in the form of NH₄⁺, alkali metal or alkaline earth metal salt, and more preferably in the form of NH₄⁺ or Na⁺ salt.

Among the structural units of the formula (V) in which R¹³ is N(CH₃)₂, preferred structural units are those which represent the polymerization product of at least one monomer species selected from the group consisting of [3-(methacryl-oylamino)propyl]dimethylamine (R¹¹=methyl; X=NH—(CₙH₂ₙ) with n=3, and R¹³=N(CH₃)₂) and [3-(acryloylamino)propyl]dimethylamine (R¹¹=H; X=NH—(CₙH₂ₙ) with n=3 and R¹³=N(CH₃)₂).

Among the structural units of the formula (V), preference is given to those which represent the polymerization product of at least one monomer species selected from the group consisting of [3-(acryloylamino)propyl]dimethylamine, [3-(methacryloylamino)propyl]dimethylamine, 2-acryloylamino-2-methylpropanesulfonic acid, and the salts of 2-acryloylamino-2-methylpropanesulfonic acid, and particular preference to those which represent the polymerization product of at least one monomer species selected from the group consisting of 2-acryloylamino-2-methylpropanesulfonic acid and the salts of 2-acryloylamino-2-methylpropanesulfonic acid.

Exceptionally preferably the one or more structural units (C) of the one or more copolymers of component Z1) of the dishwasher detergents of the invention are selected from the structural units of the formula (IV).

Very preferably the one or more structural units (C) of the one or more copolymers of component Z1) of the dishwasher detergents of the invention represent the polymerization product of at least one monomer species selected from the group consisting of acrylamide, methacrylamide, N-methylacrylamide, N,N-dimethylacrylamide, N-ethylacrylamide, N-cyclohexylacrylamide, N-benzylacrylamide, N-methylolacrylamide, N-isopropylacrylamide, and N-tert-butylacrylamide, and with further preference the one or more structural units (C) of the one or more copolymers of the component Z1) of the dishwasher detergents of the invention represent the polymerization product of at least one monomer species selected from the group consisting of N,N-dimethylacrylamide and N-isopropylacrylamide.

In one preferred embodiment of the invention, the one or more copolymers of component Z1) of the dishwasher detergents of the invention contain structural units (A), (B), and (C) as repeating structural units, but otherwise contain no further repeating structural units.

In an embodiment of the invention that is preferred among the latter, the repeating structural units of the one or more copolymers of component Z1) in the dishwasher detergents of the invention consist of the following:

20.0 to 80.0 mol %, preferably 22.0 to 77.6 mol %, of one or more cationic structural units (A) which represent the polymerization product of at least one monomer species selected from the group consisting of [3-(acryloylamino)propyl]trimethylammonium chloride, [3-(methacryloylamino)propyl]trimethylammonium chloride, and diallyldimethylammonium chloride, and preferably represent the polymerization product of [3-(methacryloylamino)propyl]trimethylammonium chloride,

0.4 to 20.0 mol %, preferably 0.5 to 4.4 mol %, of one or more macromonomeric structural units (B) of the formula (III), preferably of one or more macromonomeric structural units (B) of the formula (III) in which R^{x} is H, Z is O(CH₂)₄, l is 0, and p is on molar average a number from 22 to 150, and

15.5 to 74.6 mol %, preferably 18.0 to 74.5 mol %, of one or more structural units (C) which represent the polymerization product of at least one monomer species selected from the group consisting of N,N-dimethylacrylamide,

N-isopropylacrylamide, N-vinylpyrrolidone, 2-acryloylamino-2-methylpropanesulfonic acid, and the salts of 2-acryloylamino-2-methylpropanesulfonic acid, and preferably represent the polymerization product of at least one monomer species selected from the group consisting of N,N-dimethylacrylamide and N-isopropylacrylamide.

In a further preferred embodiment of the invention, the one or more copolymers of component Z1) of the dishwasher detergents of the invention comprise not only the structural units (A), (B), and (C) but also one or more structural units (D) which differ from the structural units (A), (B), and (C), the one or more copolymers comprising

preferably 0.1 to 99.7 mol % of the one or more structural units (A), 0.1 to 99.7 mol % of the one or more structural units (B), 0.1 to 99.7 mol % of the one or more structural units (C), and 0.1 to 99.7 mol % of the one or more structural units (D),

more preferably 20.0 to 80.0 mol % of the one or more structural units (A), 0.4 to 20.0 mol % of the one or more structural units (B), 15.5 to 74.6 mol % of the one or more structural units (C), and 0.1 to 24.6 mol % of the one or more structural units (D), and

especially preferably 22.0 to 77.6 mol % of the one or more structural units (A), 0.5 to 4.4 mol % of the one or more structural units (B), 18.0 to 72.0 mol % of the one or more structural units (C), and 0.5 to 24.6 mol % of the one or more structural units (D).

Where the one or more copolymers of component Z1) of the dishwasher detergents of the invention comprise one or more structural units (D), in one particularly preferred embodiment of the invention they comprise one or more structural units (D) selected from the structural units of the following formula (VIII):

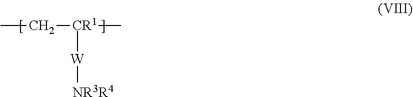

in which
W is identical or different and is represented by —CO—O—(CH₂)ₓ,
x is an integer from 1 to 6, preferably 2 or 3,
R¹ is identical or different and is hydrogen and/or methyl, and
R³ and R⁴ are each identical or different and independently of one another are each represented by hydrogen, an aliphatic hydrocarbon radical having 1 to 20, preferably 1 to 4, carbon atoms, a cycloaliphatic hydrocarbon radical having 5 to 20, preferably 5 to 8 carbon atoms, an aryl radical having 6 to 14 carbon atoms, and/or polyethylene glycol (PEG).

Where the one or more copolymers of component Z1) of the dishwasher detergents of the invention comprise one or more structural units (D), in one especially preferred embodiment of the invention these units are selected from the structural units of the formula (VIII).

Preferred among the structural units of the formula (VIII) are those which represent the polymerization product of at least one monomer species selected from the group consisting of [2-(methacryloyloxy)ethyl]dimethylamine, [2-(acryloyloxy)ethyl]dimethylamine, [2-(methacryloyloxy)ethyl]diethylamine, and [2-(acryloyloxy)ethyl]diethylamine.

Where the one or more copolymers of component Z1) of the dishwasher detergents of the invention comprise one or more structural units (D), in another particularly preferred embodiment of the invention they comprise one or more structural units (D) selected from the structural units of the following formulae (IX) and/or (X):

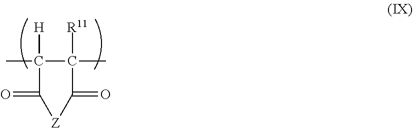

in which
R¹¹ is identical or different and is represented by H and/or methyl;
Z is identical or different and is represented by O and/or NH;

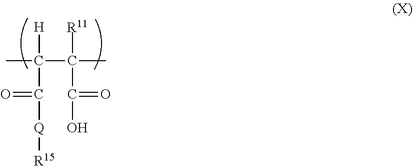

in which
R¹¹ is identical or different and is represented by H and/or methyl;
Q is identical or different and is represented by O and/or NH; and
R¹⁵ is identical or different and is represented by H, (CₙH₂ₙ)—SO₃H where n=0, 1, 2, 3 or 4; (CₙH₂ₙ)—OH where n=0, 1, 2, 3 or 4; (CₙH₂ₙ)—PO₃H₂ where n=0, 1, 2, 3 or 4; (CₙH₂ₙ)—OPO₃H₂ where n=0, 1, 2, 3 or 4; (C₆H₄)—SO₃H; (C₆H₄)—PO₃H₂; (C₆H₄)—OPO₃H₂ and/or (CₘH₂ₘ)ₑ—O-(A′O)ᵤ—R¹⁶ where m=0, 1, 2, 3 or 4, e=0, 1, 2, 3 or 4, A′=CₓCH_{2x′} where x′=2, 3, 4 or 5, u=an integer from 1 to 350, and R¹⁶ is identical or different and is represented by an unbranched or branched C₁-C₄ alkyl group.

Where the one or more copolymers of component Z1) of the dishwasher detergents of the invention comprise one or more structural units (D), in another especially preferred embodiment of the invention these units are selected from the structural units of the formulae (IX) and/or (X).

The structural units of the formula (X) may also be in salt form, preferably in the form of NH₄⁺, alkali metal or alkaline earth metal salt, and more preferably in the form of NH₄⁺ or Na⁺ salt.

Preferred among the structural units of the formulae (IX) and (X) are those which represent the polymerization product of at least one monomer species selected from the group consisting of maleic anhydride, maleic acid, and the salts of maleic acid.

Where the one or more copolymers of component Z1) of the dishwasher detergents of the invention comprise one or more structural units (D), in another particularly preferred embodiment of the invention they comprise one or more structural units (D) selected from the structural units of the following formula (VII):

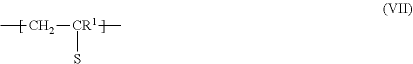

in which
S is identical or different and is represented by —COOMₖ,
R¹ is identical or different and is represented by H and/or an unbranched or branched C₁-C₄ alkyl group, and is preferably represented by H or methyl; and
M is a cation selected from the group consisting of hydrogen ion, alkali metal ion, alkaline earth metal ion, and alkaline earth metal ion, where k=valence.

Where the one or more copolymers of component Z1) of the dishwasher detergents of the invention comprise one or more structural units (D) in another especially preferred embodiment of the invention these units are selected from the structural units of the formula (VII).

Preferred among the structural units of the formula (VII) are those which represent the polymerization product of at least one monomer species selected from the group consisting of acrylic acid, sodium acrylate, potassium acrylate, methacrylic acid, sodium methacrylate, and potassium methacrylate.

Where the one or more copolymers of component Z1) of the dishwasher detergents of the invention comprise one or more structural units (D), in another particularly preferred embodiment of the invention they comprise one or more structural units (D) selected from the structural units of the following formulae (Va), (Vb) and/or (Vc):

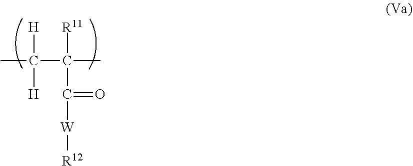

in which
R¹¹ is identical or different and is represented by H and/or methyl;
W is identical or different and is represented by O;
R¹² is identical or different and is represented by a branched or unbranched C₁-C₅ monohydroxyalkyl group;

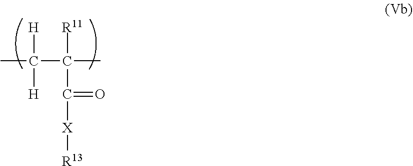

in which
R¹¹ is identical or different and is represented by H and/or methyl;
X is identical or different and is represented by O—(CₙH₂ₙ) where n=1, 2, 3 or 4;
R¹³ is identical or different and is represented by OH, SO₃H, PO₃H₂, O—PO₃H₂ and/or para-substituted C₆H₄—SO₃H;

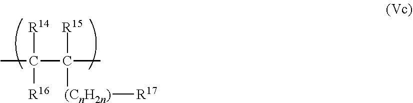

in which
R¹⁴, R¹⁵ and R¹⁶ are each identical or different and each independently of one another are represented by H and/or an unbranched or branched C₁-C₄ alkyl group;
n is identical or different and is represented by 0, 1, 2, 3 and/or 4;
R¹⁷ is identical or different and is represented by (C₆H₅), OH, OR^{y} where R^{y} is an alkyl group having 1 to 8 and preferably 4 carbon atoms, and/or —OOCCH₃.

Where the one or more copolymers of component Z1) of the dishwasher detergents of the invention comprise one or more structural units (D), in another especially preferred embodiment of the invention these units are selected from the structural units of the formulae (Va), (Vb) and/or (Vc).

The SO₃H, PO₃H₂, O—PO₃H₂, and para-substituted C₆H₄—SO₃H groups in the compounds of the formula (Vb) may also be in salt form, preferably in the form of NH₄⁺, alkali metal or alkaline earth metal salt, and more preferably in the form of NH₄⁺ or Na⁺ salt.

Preferred among the structural units of the formula (Vc) are those which represent the polymerization product of at least one monomer species selected from the group consisting of vinyl butyl ether and vinyl acetate.

In another preferred embodiment of the invention, the one or more copolymers of component Z1) of the dishwasher detergents of the invention contain structural units (A), (B), (C), and (D) as repeating structural units, but otherwise contain no further repeating structural units.

In an embodiment of the invention that is preferred among the latter, the repeating structural units of the one or more copolymers of component Z1) in the dishwasher detergents of the invention consist of the following:

20.0 to 80.0 mol %, preferably 22.0 to 77.6 mol %, of one or more cationic structural units (A) which represent the polymerization product of at least one monomer species selected from the group consisting of [3-(acryloylamino)propyl]trimethylammonium chloride, [3-(methacryloylamino)propyl]trimethylammonium chloride, and diallyldimethylammonium chloride, and preferably represent the polymerization product of [3-(methacryloylamino)propyl]trimethylammonium chloride,

0.4 to 20.0 mol %, preferably 0.5 to 4.4 mol %, of one or more macromonomeric structural units (B) of the formula (III), preferably of one or more macromonomeric structural units (B) of the formula (III) in which R^{x} is H, Z is O(CH₂)₄, l is 0, and p is on molar average a number from 22 to 150,

15.5 to 74.6 mol %, preferably 18.0 to 72.0 mol %, of one or more structural units (C) which represent the polymerization product of at least one monomer species selected from the group consisting of N,N-dimethylacrylamide,

N-isopropylacrylamide, N-vinylpyrrolidone, 2-acryloylamino-2-methylpropanesulfonic acid, and the salts of 2-acryloylamino-2-methylpropanesulfonic acid, and preferably represent the polymerization product of N,N-dimethylacrylamide and 0.1 to 24.6 mol %, preferably 0.5 to 24.6 mol %, of one or more structural units (D) which represent the polymerization product of at least one monomer species selected from the group consisting of maleic anhydride, maleic acid, and the salts of maleic acid.

Preferably the structural units (A), (B), and optionally (C) and (D) of the one or more copolymers of component Z1) of the dishwasher detergents of the invention are present in random, blockwise, alternating or gradientlike distribution in the copolymer.

Preferably the weight-average molecular weights M_{w} of the one or more copolymers of component Z1) of the dishwasher detergents of the invention are from 10 000 to 250 000 g/mol, more preferably from 15 000 to 200 000 g/mol, and especially preferably from 25 000 to 150 000 g/mol.

The weight-average molecular weight M_{w} of the copolymers of component Z1) of the dishwasher detergents of the invention can be determined by gel permeation chromatography (GPC), preferably as follows: 10 μL of the sample are injected into a PSS Novema Max Guard column of the following dimensions: 300×8 mm with a permeability of 1×30 Å and 2×1000 Å and particle size 10 μm. Detection is via the refractive index at 25° C. The eluent used is 79.7 vol % of 0.1 M NaCl+0.3 vol % of TFA (trifluoroacetic acid)+20.0 vol % of ACN (acetonitrile). Separation takes place at a flow rate of 1 mL/minute. The size is determined by comparison with the elution time of standard samples of poly(2-vinylpyridines) of defined molecular weights in the range from 1110 to 1 060 000 daltons.

The copolymers of component Z1) of the dishwasher detergents of the invention comprise repeating structural units (generally —C(R^{s1})(R^{s2})—C(R^{s3})(R^{s4})—) that are the polymerization product of corresponding monomers with polymerizable olefinic double bonds (generally C(R^{s1})(R^{s2})═C(R^{s3})(R^{s4})). The R^{s1}, R^{s2}, R^{s3}, and R^{s4} radicals here are not defined any more closely, but merely for the sake of completeness are specified as radicals bonded to the corresponding carbon atoms “C”. The structural units (A) and (B) that are present in the copolymers of component Z1), and also the structural units (C) and (D) that are optionally present additionally in the copolymers of component Z1), are, for example, repeating structural units of these kinds. Structural units that originate, for example, from radical initiators or from any chain transfer agents used in the copolymerization are not repeating structural units. Accordingly, repeating structural units are not interpreted to mean terminal groups, for example. The amounts in mol % that are stated for the structural units (A), (B), (C), and (D) are based on the total amount of the repeating structural units contained in the respective copolymers of component Z1).

The copolymers of component Z1) may be prepared by methods familiar to the skilled person. More preferably, the copolymers of component Z1) may be prepared by radical solution polymerization. Commonplace solvents may be, for example, polar solvents such as alcohols or water, and also alcohol-water mixtures. The polymerization is initiated by radical sources, such as, for example, inorganic persulfates, organic azo compounds, peroxides, inorganic redox systems, or UV light. It is also possible to use chain transfer agents which form less reactive radicals, in order to control the molecular weight of the copolymers. Chain transfer agents of this kind are, for example, phenols, thiols, as for example sodium 2-mercaptoethanesulfonate, or sodium hypophosphite. In an illustrative procedure, the monomers for preparing the copolymers of component Z1), and optionally a chain transfer agent, are dissolved in the solvent, oxygen is driven out, then the temperature is raised, and the radical initiator is metered in. The copolymerization is then carried out at the desired temperature for the desired period of time. The reaction mixture is thereafter optionally cooled and the copolymer formed is either processed further in solution or worked up; for example, the solution containing the copolymer may be concentrated by partial evaporation of the solvent, optionally under reduced pressure, or the solvent may be removed completely by evaporation, or else the copolymer may be isolated in some other way, as for example by freeze-drying or precipitation.

The dishwasher detergents of the invention preferably comprise the one or more copolymers of component Z1) in amounts from 0.0005 to 10 wt %, more preferably in amounts from 0.001 to 5 wt %, and especially preferably in amounts from 0.01 to 0.5 wt %, based in each case on the total weight of the dishwasher detergent of the invention.

Preferably the one or more enzymes of component Z2) of the dishwasher detergents of the invention are selected from the group consisting of proteases, amylases, lipases, hemicellulases, cellulases, perhydrolases, and oxidoreductases. These enzymes are typically of natural origin. Improved variants based on the natural molecules are obtainable for use in dishwasher detergents and accordingly are preferred.

Among the proteases, preference is given to those of the subtilisin type. Examples of such are the subtilisins BPN′ and Carlsberg and also the further-developed forms thereof, the protease PB92, the subtilisins 147 and 309, the alkaline protease from Bacillus lentus, subtilisin DY, and those the subtilases.

Examples of amylases which can be used in accordance with the invention are the α-amylases from Bacillus licheniformis, from B. amyloliquefaciens, from B. stearothermophilus, from Aspergillus niger and A. oryzae, and also the further-developed forms of the aforesaid amylases that have been improved for use in dishwasher detergents. Further deserving of emphasis for this purpose are the α-amylase from Bacillus sp. A 7-7 (DSM 12368) and the cyclodextrin glucanotransferase (CGTase) from B. agaradherens (DSM 9948).

Others which can be used in accordance with the invention are lipases or cutinases, particularly on the basis of their triglyceride-cleaving activities, but also for generating peracids in situ from suitable precursors. They include, for example, the lipases obtainable originally from Humicola lanuginosa (Thermomyces lanuginosus) and/or further developments thereof, particularly those with the amino acid replacement D96L. Further of possible use, for example, are the cutinases isolated originally from Fusarium solani pisi and Humicola insolens. It is also possible to use lipases, and/or cutinases, whose initial enzymes were originally isolated from Pseudomonas mendocma and Fusarium solanii.

It is possible, furthermore, to use enzymes referred to collectively as hemicellulases. These include, for example, mannanases, xanthan lyases, pectin lyases (=pectinases), pectinesterases, pectate lyases, xyloglucanases (=xylanases), pullulanases, and β-glucanases.

To increase the bleaching activity it is possible in accordance with the invention to use oxidoreductases, examples being oxidases, oxygenases, catalases, peroxidases, such as halo-, chloro-, or bromo-peroxidases, lignin, glucose or manganese peroxidases, dioxygenases or laccases (phenol oxidases, polyphenol oxidases). Added advantageously, additionally, are preferably organic, more preferably aromatic, compounds which interact with the enzymes in order to boost the activity of the oxidoreductases in question (enhancers) or in order to ensure electron flow (mediators) when there are sharp differences in redox potentials between the oxidizing enzymes and the soiling.

The enzymes can be used in any form established according to the prior art. These forms include, for example, the solid preparations obtained by granulation, extrusion or lyophilization, or else—particularly in the case of liquid or gel compositions—solutions of the enzymes, advantageously in very highly concentrated form, of low water content and/or with stabilizers added.

Alternatively the enzymes, for both the solid and the liquid presentation forms, may be encapsulated, by spray drying or extrusion of the enzyme solution, for example, together with a preferably natural polymer, or in the form of capsules, examples being those wherein the enzymes are included as in a solidified gel, or in those of the core-shell type, for which an enzyme-containing core is coated with a protective layer which is impermeable to water, air and/or chemicals. In added-on layers there may additionally be further active ingredients applied, examples being stabilizers, emulsifiers, pigments, bleaches or dyes. Capsules of these kinds are applied by techniques that are known per se, as for example by agitated granulation or roll granulation or in fluid-bed operations. Advantageously, such granules, as a result of application of polymeric film-formers, for example, are low in dust and stable in storage by virtue of the coating.

It is possible, furthermore, to formulate two or more enzymes together, so that a single type of granule has a plurality of enzyme activities.

Dishwasher detergents of the invention comprise the one or more enzymes of component Z2) preferably in amounts of 1×10⁻⁶ to 5 wt %, more preferably in amounts of 1×10⁻⁵ to 3 wt %, and especially preferably in amounts of 1×10⁻⁴ to 2 wt %, based in each case on the total weight of the dishwasher detergents of the invention. The amount of the one or more enzymes of component Z2) of the dishwasher detergents of the invention is also based on active protein. The protein concentration may be determined by known techniques, such as by the BCA method or the biuret method, for example.

The dishwasher detergents of the invention may, of course, comprise not only the one or more copolymers of component Z1) and the one or more enzymes of component Z2) but also one or more further substances. With particular preference, these further substances optionally present in the dishwasher detergents of the invention are selected from the components Z3), Z4), Z5) and/or Z6):
Z3) one or more builders as component Z3),
Z4) a bleaching system as component Z4),
Z5) one or more surfactants as component Z5),
Z6) one or more further additives, preferably selected from the group consisting of complexing agents, glass corrosion inhibitors, water, organic solvents, thickeners, foam inhibitors, color particles, silver protectants, agents for preventing tarnishing of silver, corrosion inhibitors, dyes, fillers, microbicides, hydrotropes, antioxidants, enzyme stabilizers, fragrances, solubilizers, carrier materials, processing assistants, pigments, and pH modifiers, as component Z6).

The pH of the dishwasher detergents of the invention at 20° C. is preferably from 8 to 14, more preferably from 9 to 11.5, and especially preferably from 9.5 to 11.5, measured as a 10 wt % solution of the solid or liquid dishwasher detergent of the invention in water.

The stated substances and other preferred ingredients of the dishwasher detergents of the invention are described in more detail below.

Builders

The dishwasher detergents of the invention may also comprise one or more builders.

The builders and also other constituents which may be used in the dishwasher detergents of the invention are described for example in US 2010/0160204 A1 and EP 1 757 676 A1.

The dishwasher detergents of the invention preferably comprise one or more builders of the group consisting of carbonates, hydrogencarbonates, organic builders, preferably methylglycinediacetic acid (MGDA), silicates, phosphates, phosphonates, and alkali metal hydroxides.

Preferred is the use of carbonate(s) and/or hydrogencarbonate(s), preferably alkali metal carbonate(s), more preferably sodium carbonate. These compounds are used preferably in amounts of 2 to 50 wt %, more preferably of 10 to 30 wt %, and more particularly of 10 to 25 wt %, based on the weight of the dishwasher detergent of the invention.

The organic builders include polycarboxylates, polycarboxylic acids, polymeric carboxylates, aspartic acid, polyacetals, and dextrins.

Useful organic builders include the polycarboxylic acids, which can be used in the form of the free acid and/or the sodium salts thereof, with polycarboxylic acids being understood to mean those carboxylic acids which carry more than one acid function. These are, for example, citric acid, adipic acid, succinic acid, glutaric acid, malic acid, tartaric acid, maleic acid, fumaric acid, sugar acids, aminocarboxylic acids, and nitrilotriacetic acid (NTA), and also mixtures thereof. The free acids typically also possess the property of an acidifying component, as well as their builder effect, and hence also serve to establish a lower and milder pH for the dishwasher detergents of the invention. Deserving of mention in this context in particular are citric acid, succinic acid, glutaric acid, adipic acid, gluconic acid, tartaric acid, and any desired mixtures thereof.

Examples of customary aminocarboxylic acids which are preferred in the context of the present invention are ethylenediaminetetraacetic acid (EDTA), methylglycinediacetic acid (MGDA), and glutaminediacetic acid (GLDA). Mixtures can also be used.

Also to be mentioned as further preferred builders are polymeric aminodicarboxylic acids, their salts, or their precursor substances. Particular preference is given to using polyaspartic acids, their salts and/or their derivatives.

Having proven particularly advantageous for the cleaning and rinse performance of dishwasher detergents of the invention is the use of citric acid and/or citrates in these compositions. Preference is therefore given to dishwasher detergents of the invention which comprise citric acid or a salt of citric acid, in which case the weight fraction of the citric acid or of the salt of citric acid is preferably from 2 to 50 wt %, more preferably 5 to 30 wt %, and especially preferably 10 to 30 wt %, based in each case on the total weight of the dishwasher detergent of the invention.

In another preferred embodiment of the invention, the dishwasher detergents of the invention comprise MGDA as one of their builders. Dishwasher detergents of the invention comprise preferably 0.5 to 25 wt % and more preferably 2 to 25 wt % of MGDA, based on the total weight of the dishwasher detergent of the invention.

Also suitable as organic builders are polymeric carboxylates. These are, for example, the alkali metal salts of polyacrylic acid or of polymethacrylic acid, examples being those having a relative molecular mass of 500 to 70 000 g/mol. Suitable polymeric carboxylates are, in particular, polyacrylates, preferably having a molecular mass of 2000 to 20 000 g/mol. By virtue of their superior solubility, preference may be given in turn, from this group, to the short-chain polyacrylates having molar masses of 2000 to 10 000 g/mol and more preferably of 3000 to 5000 g/mol.

Additionally suitable are copolymeric carboxylates. Suitable comonomers are monoethylenically unsaturated dicarboxylic acids such as maleic acid, fumaric acid, maleic anhydride, itaconic acid, and citraconic acid. Especially suitable are copolymeric carboxylates of acrylic acid with methacrylic acid and of acrylic acid or methacrylic acid with maleic acid and/or fumaric acid. Having proved particularly suitable are copolymers of acrylic acid with maleic acid which contain 50 to 90 wt % of acrylic acid and 10 to 50 wt % of maleic acid. Their relative molecular mass, based on free acids, is preferably 2000 to 70 000 g/mol, more preferably 20 000 to 50 000 g/mol, and especially 30 000 to 40 000 g/mol.

It is also possible to use copolymers of at least one monomer from the group consisting of monoethylenically unsaturated C₃-C₁₀ monocarboxylic and/or C₄-C₁₀ dicarboxylic acids or their anhydrides, such as maleic acid, maleic anhydride, acrylic acid, methacrylic acid, fumaric acid, itaconic acid, and citraconic acid, with at least one hydrophilically or hydrophobically modified monomer as recited below.

Suitable hydrophobic monomers are, for example, isobutene, diisobutene, butane, pentene, hexene, and styrene, olefins having 10 or more carbon atoms or mixtures thereof, such as, for example, 1-decene, 1-dodecene, 1-tetradecene, 1-hexadecene, 1-octadecene, 1-eicosene, 1-docosene, 1-tetracosene, and 1-hexacosene, C₂₂ α-olefin, a mixture of C₂₀-C₂₄ α-olefins and polyisobutene having on average 12 to 100 carbon atoms per molecule.

Suitable hydrophilic monomers are monomers having sulfonate or phosphonate groups, and also nonionic monomers with hydroxy function or alkylene oxide groups, and optionally further ionic or nonionic monomers.

Examples of the above-recited hydrophilic monomers are allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate, and ethoxypoly(propylene oxide-co-ethylene oxide) (meth)acrylate. Polyalkylene glycols here may contain 3 to 50, especially 5 to 40, and in particular 10 to 30 alkylene oxide units per molecule.

Particularly preferred monomers containing sulfonic acid groups here are 1-acrylamido-1-propanesulfonic acid, 2-acrylamido-2-propanesulfonic acid, 2-acrylamido-2-methylpropanesulfonic acid (2-acryloylamino-2-methylpropanesulfonic acid), 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and also salts of the stated acids, such as their sodium, potassium or ammonium salts.

Particularly preferred monomers containing phosphonate groups are vinylphosphonic acid and its salts.

Furthermore, amphoteric polymers may also be used as builders.

If the dishwasher detergents of the invention comprise one or more (co)polymeric carboxylates, the amount of these (co)polymeric carboxylates in the dishwasher detergent of the invention is preferably 0.5 to 20 wt % and more particularly 3 to 10 wt %, based on the total weight of the dishwasher detergent of the invention. Oxydisuccinates and other derivatives of disuccinates, preferably ethylenediaminedisuccinate, are also further preferred organic builders, which are frequently also referred to as cobuilders. In this case, ethylenediamine-N,N′-disuccinate (EDDS) is used preferably in the form of its sodium or magnesium salts. Further preferred as builder or cobuilder in this context are also glyceroldisuccinates and glyceroltrisuccinates.

Dishwasher detergents of the invention may as builders preferably comprise crystalline sheetlike sodium silicates of the formula NaMSiₓO₂ₓ₊₁.yH₂O, in which M is sodium or hydrogen, x is a number from 1.9 to 22, preferably from 1.9 to 4, with particularly preferred values for x being 2, 3 or 4, and y is a number from 0 to 33, preferably 0 to 20.

The dishwasher detergents of the invention comprise preferably a weight fraction of the crystalline sheetlike silicate of the formula NaMSiₓO₂ₓ₊₁.yH₂O of 0.1 to 20 wt %, more preferably of 0.2 to 15 wt %, and more particularly of 0.4 to 10 wt %, based in each case on the total weight of the dishwasher detergents of the invention.

Also employable are amorphous sodium silicates having an Na₂O:SiO₂ modulus of 1:2 to 1:3.3, preferably of 1:2 to 1:2.8, and more particularly of 1:2 to 1:2.6, which are preferably dissolution-retarded and have secondary cleaning properties. Retarded dissolution relative to conventional amorphous sodium silicates may have been brought about in a variety of ways, as for example by surface treatment, compounding, compacting, densification, or by overdrying. For the purposes of this invention, the term “amorphous” is understood to mean that in x-ray diffraction experiments, the silicates provide none of the sharp x-ray reflections of the kind typical of crystalline substances, but instead invoke at most one or more maxima in the scattered x-radiation, with a latitude of several degree units of the diffraction angle.

Alternatively or in combination with the aforesaid amorphous sodium silicates, x-ray-amorphous silicates are used, whose silicate particles in electron diffraction experiments yield indistinct or even sharp diffraction maxima. This is to be interpreted to mean that the products have microcrystalline regions of ten to several hundred nm in size, with preference being given to values up to a maximum of 50 nm and more particularly up to a maximum of 20 nm. X-ray-amorphous silicates of this kind likewise have retarded dissolution in relation to the conventional waterglasses. Especially preferred are densified/compacted amorphous silicates, compounded amorphous silicates, and overdried x-ray-amorphous silicates.

In accordance with the present invention it is preferred for these silicates, preferably alkali metal silicates, more preferably crystalline or amorphous alkali metal disilicates, to be present in the dishwasher detergents of the invention in amounts of 3 to 60 wt %, preferably of 8 to 50 wt %, and more particularly of 20 to 40 wt %, based in each case on the total weight of the dishwasher detergent of the invention.

The phosphates have proven to be effective builders in relation to the cleaning performance. Among the multiplicity of phosphates available commercially, the greatest significance in the detergents industry is possessed by the alkali metal phosphates, especially pentasodium and/or pentapotassium triphosphate (sodium and/or potassium tripolyphosphate).

Alkali metal phosphates here is the overarching designation for the alkali metal salts (especially sodium and potassium salts) of the various phosphoric acids, among which it is possible to differentiate metaphosphoric acids (HPO₃)ₘ and orthophosphoric acid H₃PO₄, as well as representatives of higher molecular mass. The phosphates here unite a number of advantages: they act as alkali metal carriers, prevent limescale deposits on machine components, and contribute to the cleaning performance.

Phosphates particularly important technically are pentasodium triphosphate Na₅P₃O₁₀ (sodium tripolyphosphate) and also the corresponding potassium salt pentapotassium triphosphate K₅P₃O₁₀ (potassium tripolyphosphate). Also used preferably in accordance with the invention are the sodium potassium tripolyphosphates.

Where phosphates are used in the dishwasher detergents of the invention, preferred compositions comprise phosphate(s), preferably alkali metal phosphate(s), more preferably pentasodium and/or pentapotassium triphosphate (sodium and/or potassium tripolyphosphate), in amounts of 2 to 50 wt %, preferably of 2 to 30 wt %, more preferably of 3 to 25 wt %, and very preferably of 3 to 15 wt %, based in each case on the weight of the dishwasher detergent of the invention.

Further builders which the dishwasher detergents of the invention may comprise are one or more phosphonates, which are frequently also referred to as cobuilders. The weight fraction of phosphonate, based on the total weight of the dishwasher detergent of the invention, is preferably 0.5 to 20 wt % and more preferably 1.0 to 10 wt %.

The complex-forming phosphonates embrace a series of different compounds such as, for example, 1-hydroxyethane-1,1-diphosphonic acid (HEDP) or diethylenetriaminepenta(methylenephosphonic acid) (DTPMP). Particularly preferred are hydroxyalkane- and aminoalkanephosphonates. Among the hydroxyalkanephosphonates, particular significance, preferably as a cobuilder, is possessed by 1-hydroxyethane-1,1-diphosphonate (HEDP). It is used preferably as the sodium salt, with the disodium salt giving a neutral reaction and the tetrasodium salt an alkaline reaction (pH 9). Suitable aminoalkanephosphonates include ethylenediaminetetramethylenephosphonate (EDTMP), diethylenetriaminepentamethylenephosphonate (DTPMP), and also their higher homologs. They are used preferably in the form of the neutrally reacting sodium salts (e.g., as the hexasodium salt of EDTMP and/or as the hepta- and octasodium salt of DTPMP). From the class of the phosphonates, preference is given to using HEDP.

Dishwasher detergents of the invention may comprise alkali metal hydroxides as further builders. These alkali metal carriers are preferably used only in small amounts, preferably in amounts of 10 wt % or less, more preferably 6 wt % or less, preferably 5 wt % or less, very preferably 0.1 to 5 wt %, and more particularly 0.5 to 5 wt %, based on the total weight of the dishwasher detergent of the invention.

In a further preferred embodiment of the invention, the dishwasher detergents of the invention comprise one or more builders from the group of the organic builders. In one particularly preferred embodiment of the invention, the dishwasher detergents of the invention comprise one or more builders from the group consisting of citrate, methylglycinediacetic acid (MGDA), and ethylenediamine-N,N′-disuccinate (EDDS). In an especially preferred embodiment of the invention the dishwasher detergents of the invention comprise MGDA.

The dishwasher detergents of the invention may comprise the aforesaid builders either individually or else in the form of mixtures of two, three, four or more builders.

In one preferred embodiment of the invention the dishwasher detergents of the invention contain no phosphate builders.

The dishwasher detergents of the invention comprise the one or more builders of component Z3) preferably in amounts of 2 to 50 wt %, more preferably in amounts of 10 to 30 wt %, and especially preferably in amounts of 10 to 25 wt %, based in each case on the total weight of the dishwasher detergent of the invention.

Bleaching System

The dishwasher detergents of the invention may also comprise a bleaching system.

The bleaching system of the dishwasher detergents of the invention comprises preferably one or more substances from the group consisting of bleaches, bleach activators, and bleaching catalysts.

As bleaches, the dishwasher detergents of the invention may comprise an oxygen bleach. Among these oxygen bleaches, which in water yield H₂O₂, particular importance is possessed by sodium percarbonate, sodium perborate tetrahydrate, and sodium perborate monohydrate. Examples of other useful bleaches are peroxypyrophosphates, citrate perhydrates, and also H₂O₂-donating peracid salts or peracids, such as perbenzoates, peroxophthalates, diperazelaic acid, phthaloimino peracid or diperdodecanedioic acid. Organic bleaches can also be used. Typical organic bleaches are the diacyl peroxides, such as dibenzoyl peroxide. Further typical organic bleaches are the peroxy acids, such as alkylperoxy acids and the arylperoxy acids.

The dishwasher detergents of the invention preferably comprise one or more bleaches from the group consisting of oxygen bleaches, peroxypyrophosphates, citrate perhydrates, H₂O₂-donating peracid salts or peracids, and organic bleaches.

With particular preference the dishwasher detergents of the invention comprise 1.0 to 20 wt %, preferably 4.0 to 18 wt %, and more preferably 8 to 15 wt %, of an oxygen bleach, preferably sodium carbonate, based in each case on the total weight of the dishwasher detergent of the invention.

In order to achieve an improved bleaching effect when cleaning at temperatures of around 60° C. and below, the dishwasher detergents of the invention may additionally comprise one or more bleach activators. The bleach activator or bleach activators are preferably selected from the group consisting of compounds which under perhydrolysis conditions furnish aliphatic peroxycarboxylic acids having preferably 1 to 10 carbon atoms, especially 2 to 4 carbon atoms, and/or optionally substituted perbenzoic acid. Suitable substances are those which carry O- and/or N-acyl groups with the stated number of carbon atoms, and/or optionally substituted benzoyl groups. Preferred are polyacylated alkylenediamines, with tetraacetylethylenediamine (TAED) having proven particularly suitable.

Bleach activators, especially TAED, are used preferably in amounts of up to 10 wt %, more preferably in amounts of 0.1 to 8 wt %, especially preferably in amounts of 2 to 8 wt %, and exceptionally preferably in amounts of 2 to 6 wt %, based in each case on the total weight of the bleach activator-containing dishwasher detergent of the invention.

Further to the conventional bleach activators or in their place, use may also be made of what are called bleaching catalysts. These compounds are bleach-boosting transition metal salts or transition metal complexes such as, for example, Mn-, Fe-, Co-, Ru- or Mo-salen complexes or -carbonyl complexes. Also possible for use as bleaching catalysts are Mn, Fe, Co, Ru, Mo, Ti, V, and Cu complexes with nitrogen-containing tripod ligands, and also Co-, Fe-, Cu-, and Ru-amine complexes.

Particular preference is given to using complexes of manganese in the II, III, IV or V oxidation state, preferably containing one or more macrocyclic ligands with N, NR, PR, O and/or S donor functions. Preferred ligands are those having nitrogen donor functions. It is particularly preferred in that case to use bleaching catalyst(s) comprising as macromolecular ligands 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN). Examples of suitable manganese complexes are [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁ (μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂, and [Mn^{IV}₂(μ-O)₃(Me/Me-TACN)₂](PF₆)₂(OAc=OC(O)CH₃).

In another preferred embodiment of the invention, the dishwasher detergents of the invention comprise one or more bleaching catalysts from the group of the bleach-boosting transition metal salts and transition metal complexes, preferably from the group of the manganese complexes with 1,4,7-trimethyl-1,4,7-triazacyclononane (Me-TACN) and 1,2,4,7-tetramethyl-1,4,7-triazacyclononane (Me₄-TACN), since by means of these bleaching catalysts it is possible to pose significant improvements in the cleaning outcome.

The bleaching system preferably comprises one or more bleaches and one or more substances from the group of the bleach activators and bleaching catalysts. With particular preference the bleaching system comprises one or more bleaches, one or more bleach activators, and one or more bleaching catalysts.

The dishwasher detergents of the invention comprise the bleaching system of component Z4) preferably in amounts of 1 to 40 wt %, more preferably in amounts of 0.5 to 30 wt %, and especially preferably in amounts of 3 to 25 wt %, based in each case on the total weight of the dishwasher detergent of the invention.

Surfactants

Preferred dishwasher detergents of the invention further comprise one or more surfactants of component Z5), the group of the surfactants including the nonionic, the anionic, the cationic, and the amphoteric surfactants.

The one or more surfactants of component Z5) of the dishwasher detergents of the invention are preferably selected from the group of the nonionic surfactants, more particularly of the low-foaming nonionic surfactants. Nonionic surfactants which can be used in the context of the present invention are all nonionic surfactants known to the skilled person.

With particular preference the one or more surfactants of component Z5) of the dishwasher detergents of the invention are selected from the group of nonionic surfactants consisting of fatty alcohol alkoxylates, endgroup-capped fatty alcohol alkoxylates, ethylene oxide propylene oxide block copolymers, N-acylglucamides, and epoxy-capped poly(alkoxylated) alcohols.

Especially preferred are dishwasher detergents of the invention wherein the one or more surfactants of component Z5) are selected from the group of the nonionic surfactants of the formula (XI)

RₐO—(-AO—)ₓ—Y (XI),
in which
Rₐ is a linear or branched saturated alkyl group having 8 to 30 carbon atoms, or a linear or branched unsaturated alkenyl group having one or more double bonds and 8 to 30 carbon atoms,
A is selected from the group consisting of —C₂H₄— and —C₃H₆—,
x is a number from 1 to 150,
Y is H, a linear or branched alkyl group having 1 to 30 carbon atoms, or a group —CH(OH)—R_{b}, and R_{b} is a linear or branched alkyl group having 1 to 30 carbon atoms, and where the group -(-AO—)ₓ— comprises one or more —C₂H₄O— groups and may additionally comprise one or more —C₃H₆O— groups, and, when the group -(-AO—)ₓ— simultaneously comprises —C₂H₄O— and —C₃H₆O— groups, the —C₂H₄O— and —C₃H₆O— groups may be distributed over the -(-AO—)ₓ— group in any desired way, preferably in random, gradientlike or blocklike manner and more preferably in blocklike manner, and the molar amount of the —C₂H₄O— groups in the group -(-AO—)ₓ— is preferably greater than the molar amount of the —C₃H₆O— groups.

Examples of the alkyl and alkenyl groups Rₐ in the formula (XI) are, for example, the alkyl and alkenyl groups of the following alcohols Rₐ—OH: 1-octanol (caprylyl alcohol), 2-ethylhexanol, 1-nonanol (pelargon alcohol), 1-decanol (caprinyl alcohol), 1-undecanol, 1-dodecanol (lauryl alcohol), 1-tridecanol, isotridecanol, 1-tetradecanol (myristyl alcohol), 1-pentadecanol, 1-hexadecanol (cetyl alcohol), cis-9-hexadecen-1-ol (palmitoleyl alcohol), 1-heptadecanol, 1-octadecanol (stearyl alcohol), cetearyl alcohol, 16-methylheptadecan-1-ol (isostearyl alcohol), 9E-octadecen-1-ol (elaidyl alcohol), cis-9-octadecen-1-ol (oleyl alcohol), oleyl cetyl alcohol (i.e., a mixture of oleyl alcohol and cetyl alcohol), 9Z,12Z-octadecadien-1-ol (linoleyl alcohol), 9E,12E-octadecadien-1-ol (elaidolinoleyl alcohol), 9Z,12Z,15Z-octadecatrien-1-ol (linolenyl alcohol), 9E,12E,15E-octadecatrien-1-ol (elaidolinolenyl alcohol), 1-nonadecanol, 1-eicosanol (arachidyl alcohol), 1-heneicosanol, 1-docosanol (behenyl alcohol), cis-13-docosen-1-ol (erucyl alcohol), 1-tetracosanol (lignoceryl alcohol), 1-hexacosanol (ceryl alcohol), 1-octacosanol (montanyl alcohol), and 1-triacontanol (myricyl alcohol), or mixtures thereof.

Rₐ in formula (XI) is preferably a linear or branched saturated alkyl group having 8 to 22 carbon atoms, or a linear or branched unsaturated alkenyl group having one or more double bonds and 8 to 22 carbon atoms, more preferably a linear or branched saturated alkyl group having 8 to 18 carbon atoms, or a linear or branched unsaturated alkenyl group having one or more double bonds and 8 to 18 carbon atoms, and especially preferably a linear or branched saturated alkyl group having 12 to 15 carbon atoms, or a linear or branched unsaturated alkenyl group having one or more double bonds and 12 to 15 carbon atoms.

Preferably the groups Rₐ in formula (XI) are alkyl groups.

In formula (XI), x is preferably a number from 1 to 50, more preferably a number from 1 to 20, and especially preferably a number from 5 to 20.

Examples of the alkyl groups Y and R_{b} in the compounds of the formula (XI) include the examples specified above for the alkyl group Rₐ in the compound of the formula (XI). Further examples are the alkyl groups methyl, ethyl, n-propyl, isopropyl, n-butyl, sec-butyl, isobutyl, tert-butyl, n-pentyl, sec-pentyl (2-pentyl), 3-pentyl, 2-methylbutyl, isopentyl (3-methylbutyl), 3-methylbut-2-yl, 2-methylbut-2-yl, neopentyl (2,2-dimethylpropyl), 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 2,3-dimethyl-1-butyl, 3,3-dimethyl-1-butyl, 2,3-dimethyl-2-butyl, 3,3-dimethyl-2-butyl, 2-ethyl-1-butyl, 1-heptyl, 2-heptyl, 3-heptyl, and 4-heptyl.

If Y in formula (XI) is a linear or branched alkyl group, the alkyl group in question preferably has 1 to 22 carbon atoms.

R_{b} in formula (XI) is preferably a linear or branched alkyl group having 8 to 22 carbon atoms.

In one preferred embodiment of the invention, the group -(-AO—)ₓ— consists of one or more —C₂H₄O— groups and contains no —C₃H₆O— groups.

In another preferred embodiment of the invention, the group -(-AO—)ₓ— comprises one or more —C₂H₄O— groups and one or more —C₃H₆O— groups. In this preferred embodiment of the invention, the molar amount of the —C₃H₆O— groups, based on the total amount of —C₂H₄O— and —C₃H₆O— groups, is preferably less than 50%, more preferably 45% or less than 45%, especially preferably 40% or less than 40%, and exceptionally preferably 33% or less than 33%.

In another preferred embodiment of the invention, Y in formula (XI) is H. In this preferred embodiment of the invention, the molar amount of the —C₃H₆O— groups, based on the total amount of —C₂H₄O— and —C₃H₆O— groups, is preferably 20 to less than 50%, more preferably 33 to 45%, and especially preferably 33 to 40%.

If Y has a definition other than H, the molar amount of the —C₃H₆O— groups, based on the total amount of —C₂H₄O— and —C₃H₆O— groups, is preferably 20% or less than 20% and more preferably 10% or less than 10%.

In another preferred embodiment of the invention, Y in formula (XI) is an alkyl group with 1 to 4 carbon atoms. In this preferred embodiment the molar amount of the —C₃H₆O— groups, based on the total amount of —C₂H₄O— and —C₃H₆O— groups, is preferably 20% or less than 20% and more preferably 10% or less than 10%.

In another embodiment of the invention, Y in formula (XI) is the group —CH(OH)—R_{b}, in which R_{b} is a linear or branched alkyl group having 8 to 22 carbon atoms. In this preferred embodiment the molar amount of the —C₃H₆O— groups, based on the total amount of —C₂H₄O— and —C₃H₆O— groups, is preferably 20% or less than 20% and more preferably 10% or less than 10%.

In one particularly preferred embodiment of the invention, the one or more nonionic surfactants of component Z5) of the dishwasher detergents of the invention comprise on molar average 8 —C₂H₄O— groups and 4 —C₃H₆O— groups and Rₐ is a linear or branched saturated alkyl group having 12 to 15 carbon atoms, or a linear or branched unsaturated alkenyl group having one or more double bonds and 12 to 15 carbon atoms. In these nonionic surfactants of component Z5) of the dishwasher detergents of the invention, Y is preferably H.

The one or more nonionic surfactants of component Z5) of the dishwasher detergents of the invention have with particular preference a cloud point of 40 to 60° C.

The one or more nonionic surfactants of component Z5) are present in the dishwasher detergents of the invention preferably in amounts of 0.1 to 15 wt %, more preferably in amounts of 0.2 to 10 wt %, and especially preferably in amounts of 0.2 to 5 wt %, based in each case on the total weight of the dishwasher detergent of the invention.

The variable “x” in the one or more compounds of the formula (XI) represents molar averages, meaning that the dishwasher detergents of the invention may comprise a plurality of compounds of the formula (XI) having different degrees of alkoxylation.

Especially preferred, furthermore, are dishwasher detergents of the invention wherein the one or more surfactants of component Z5) are selected from the group of the N-acylglucamines, which are also known as N-1-deoxysorbityl-fatty acid amides or glucamides, of the formula (XII),

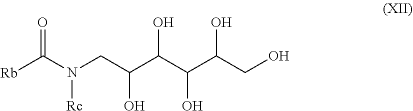

in which
Rb is a linear or branched saturated alkyl group having 11 to 21 carbon atoms, or a linear or branched unsaturated alkenyl group having one or more double bonds and 11 to 21 carbon atoms, and
Rc is hydrogen or a linear or branched saturated alkyl group having 1 to 4 carbon atoms.

In the one or more N-acylglucamines of the formula (XII), Rc is preferably a methyl group.

In the one or more N-acylglucamines of the formula (XII), Rb is preferably a linear or branched saturated alkyl group having 11 to 17 carbon atoms, or a linear or branched unsaturated alkenyl group having one or more double bonds and 11 to 17 carbon atoms.

In the one or more N-acylglucamines of the formula (XII), Rb is more preferably a linear or branched saturated alkyl group having 15 to 17 carbon atoms, or a linear or branched unsaturated alkenyl group having one or more double bonds and 15 to 17 carbon atoms.

In one preferred embodiment of the invention, 50 wt % or more, more preferably 60 to 99 wt %, and especially preferably 70 to 98 wt %, of the groups Rb in the one or more N-acylglucamines of the formula (XII) are linear or branched saturated alkyl groups having 17 carbon atoms.

In a further preferred embodiment of the invention, 0.1 to 50 wt %, more preferably 0.5 to 40 wt %, and especially preferably 1.0 to 30 wt % of the groups Rb in the one or more N-acylglucamines of the formula (XII) are linear or branched saturated alkyl groups having 15 carbon atoms.

In a further preferred embodiment of the invention, 50 wt % or more of the groups Rb in the one or more N-acylglucamines of the formula (XII) are linear or branched unsaturated alkenyl groups having one or more double bonds.

In one particularly preferred embodiment of the invention, 50 wt % or more, especially preferably 80 wt % or more and exceptionally preferably 90 wt % or more of the groups Rb in the one or more N-acylglucamines of the formula (XII) are linear or branched alkenyl groups having one or more double bonds and 17 carbon atoms.

In the one or more N-acylglucamines of the formula (XII), Rb is more preferably a linear group.

In another preferred embodiment of the invention, RbCO in the one or more N-acylglucamines of the formula (XII) derives from lauric acid, palmitic acid, stearic acid, oleic acid, linoleic acid or linolenic acid. In a particularly preferred embodiment of the invention, RbCO in the one or more N-acylglucamines of the formula (XII) derives from stearic acid, oleic acid, linoleic acid or linolenic acid. In an especially preferred embodiment of the invention, RbCO in the one or more N-acylglucamines of the formula (XII) derives from oleic acid, linoleic acid, and linolenic acid, and in an exceptionally preferred embodiment of the invention RbCO in the one or more N-acylglucamines of the formula (XII) derives from oleic acid.

The dishwasher detergents of the invention comprise the one or more surfactants of component Z5) preferably in amounts of 0.1 to 15 wt %, more preferably in amounts of 0.2 to 10 wt %, and especially preferably in amounts of 0.2 to 5 wt %, based in each case on the total weight of the dishwasher detergent of the invention.

Further preferred are dishwasher detergents of the invention wherein the one or more surfactants of the component Z5) are selected from the group of the zwitterionic surfactants, anionic surfactants, and mixtures thereof.

The zwitterionic surfactant is preferably selected from the group consisting of C₈ to C₁₈ (preferably C₁₂ to C₁₈) amine oxides and sulfobetaines and hydroxylbetaines, such as N-alkyl-N,N-dimethylamino-1-propanesulfonate, where the alkyl group may be C₉ to C₁₈, preferably C₁₀ to C₁₄.

The anionic surfactant is preferably selected from alkyl ethoxysulfates having a degree of ethoxylation of more than 3, more preferably 4 to 10, and especially preferably 6 to 8, and a chain length in the range from C₈ to C₁₆ and preferably C₁₁ to C₁₅. Also, branched alkyl carboxylates have proven useful for the purposes of the present invention if the branching occurs in the middle and the average overall chain length is 10 to 18 and preferably 12 to 16 in the case of a side-chain length of 2 to 4 carbon atoms. One example thereof is 2-butyloctanoic acid. The anionic surfactant is commonly of a type having good solubility in the presence of calcium. Anionic surfactants of this kind are further represented by sulfobetaines, alkyl (polyethoxy)sulfates (AES), and short-chain C₆-C₁₀ alkyl sulfates and alkylsulfonates. It has emerged that straight-chain fatty acids are ineffective because of their sensitivity toward calcium.

Additives

The dishwasher detergents of the invention may comprise further ingredients which are commonly used in dishwasher detergents. In a further preferred embodiment of the invention, the dishwasher detergents of the invention comprise one or more substances selected from the group consisting of complexing agents, glass corrosion inhibitors, water, organic solvents, thickeners, foam inhibitors, color particles, silver protectants, agents for preventing the tarnishing of silver, corrosion inhibitors, dyes, fillers, microbicides, hydrotropes, antioxidants, enzyme stabilizers, fragrances, solubilizers, carrier materials, processing assistants, pigments, and pH modifiers.

Glass corrosion inhibitors are further preferred ingredients of the dishwasher detergents of the invention. Glass corrosion inhibitors prevent the appearance of clouding, streaks and scratches, but also prevent the surface of machine-cleaned glassware becoming iridescent. Preferred glass corrosion inhibitors include salts of magnesium, cobalt, zinc, and also complexes of magnesium, cobalt, and zinc.

A protein and/or enzyme may be protected, particularly during storage, against forms of damage such as inactivation, denaturing or disintegration (as a result, for example, of physical influences, oxidation or proteolytic cleavage). Where the proteins and/or enzymes are obtained microbially, inhibition of proteolysis is particularly preferred, especially if the dishwasher detergents of the invention also comprise proteases. Dishwasher detergents of the invention may comprise stabilizers for this purpose. The provision of such agents in dishwasher detergents of the invention represents a preferred embodiment of the present invention.

Preference is given in particular to those dishwasher detergents which comprise 0.1 to 12 wt %, more preferably 0.2 to 10 wt %, and especially preferably 0.5 to 8 wt %, of enzyme preparation, based in each case on the total weight of the dishwasher detergent of the invention.

The cleaning performance of dishwasher detergents of the invention may be improved through the addition of organic solvents. In one preferred embodiment of the present invention, therefore, dishwasher detergents of the invention comprise at least one organic solvent. Preferred liquid dishwasher detergents of the invention comprise organic solvent in amounts of 0.2 to 15 wt %, more preferably in amounts of 0.5 to 12 wt %, and especially preferably in amounts of 1.0 to 10 wt %, based in each case on the total weight of the dishwasher detergent of the invention.

These organic solvents are, for example, monoalcohols, diols, triols, polyols, ethers, esters and/or amides. Particularly preferred here are organic solvents which are water-soluble, with “water-soluble” solvents in the sense of the present specification being solvents which at room temperature are miscible with water completely (i.e., without a miscibility gap).

The organic solvents from the group of the organic amines and/or the alkanolamines are effective in relation to the cleaning performance and especially in relation to the cleaning performance on bleachable stains, particularly on tea stains.

To achieve the desired viscosity of the liquid dishwasher detergents of the invention, these compositions may have thickeners added to them. In the dishwasher detergents of the invention it is possible to use the thickeners that are typically used in dishwasher detergents.

The respective liquid dishwasher detergents of the invention advantageously comprise the thickener in amounts which are preferably from 0.1 to 8 wt %, more preferably from 0.2 to 6 wt %, and especially preferably from 0.4 to 4 wt %, based on the total weight of the dishwasher detergent of the invention.

The foam inhibitors, color particles, silver protectants, agents for preventing the tarnishing of silver, corrosion inhibitors, dyes, fillers, microbicides, hydrotropes, antioxidants, enzyme stabilizers, fragrances, solubilizers, carrier materials, processing assistants, pigments, and pH modifiers may be selected from the corresponding substances which are typically used in dishwasher detergents.

With particular preference the dishwasher detergents of the invention comprise
Z1) 0.0005 to 10 wt % of component Z1),
Z2) 1×10⁻⁶ to 5 wt % of component Z2),
Z3) 2 to 50 wt % of component Z3),
Z4) 1 to 40 wt % of component Z4),
Z5) 0.10 to 15 wt % of component Z5), and
Z6) 0 to 10 wt % of component Z6)
based in each case on the total weight of the dishwasher detergent of the invention.

In a further preferred embodiment of the invention, the dishwasher detergents of the invention contain no phosphate-based builders, and with particular preference the dishwasher detergents of the invention contain no phosphates, i.e., they are phosphate-free.

The dishwasher detergents of the invention may be produced in solid or liquid form and also as a combination of solid and liquid presentation forms.

Preferred dishwasher detergents of the invention are those which are solid at 20° C. Suitable solid presentation forms include, in particular, powders, granules, extrudates or compacts, especially tablets, in single-phase or multiphase form. Tablets are formulated for single-dose applications. The solid compositions of the invention preferably comprise less than 20 wt % of water, more preferably 0.1 to 20 wt % of water, and especially preferably 0.5 to 5 wt % of water, based in each case on the total weight of the dishwasher detergent of the invention. In another preferred embodiment of the invention, the dishwasher detergents of the invention are anhydrous.

In one especially preferred embodiment of the invention, the dishwasher detergents of the invention are in the form of tablets.

In a further preferred embodiment of the invention, the dishwasher detergents of the invention are liquid at 20° C. The liquid presentation forms, preferably based on water and/or organic solvents, may be present in a thickened form as gels. Capsules as a liquid presentation form, in single-phase or multiphase form, are especially suitable. The liquid dishwasher detergents of the invention contain preferably up to 60 wt % of water, more preferably from 10 to 60 wt % of water, and especially preferably 25 to 60 wt % of water, based in each case on the total weight of the liquid dishwasher detergent of the invention.

The dishwasher detergents of the invention are advantageously suitable for cleaning dishes in dishwashers, where soiled dishes are treated in a dishwasher with an aqueous alkaline composition comprising a dishwasher detergent of the invention.

A further subject of the invention is therefore a method for cleaning dishes in a dishwasher, wherein soiled dishware are treated in a dishwasher with an aqueous alkaline composition comprising a dishwasher detergent of the invention.

In the method of the invention for cleaning dishware, the pH of the aqueous alkaline composition is preferably 8 or more and more preferably 9 or more.

The dishwasher detergents of the invention or the one or more copolymers of component Z1) of the dishwasher detergents of the invention are advantageously suitable as rinse agents in machine dishwashing, preferably in a method of the invention for cleaning dishware in a dishwasher.

A further subject of the present invention is therefore the use of a dishwasher detergent of the invention or of one or more copolymers of component Z1) of the dishwasher detergents of the invention as rinse agents in machine dishwashing, preferably in a method of the invention for cleaning dishes in a dishwasher.

The dishwasher detergents of the invention or the one or more copolymers of component Z1) of the dishwasher detergents of the invention are advantageously suitable for improving the wettability of dishware, for reducing the spotting and filming on dishware, for improving the rinse performance of a dishwasher detergent, preferably of a dishwasher detergent of the invention, or for improving the drying performance of a dishwasher detergent, preferably of a dishwasher detergent of the invention, more preferably in a method of the invention for cleaning dishware in a dishwasher.

A further subject of the present invention is the use of a dishwasher detergent of the invention or of one or more copolymers of component Z1) of the dishwasher detergents of the invention for improving the wettability of dishware or for reducing the spotting and filming on dishware, preferably in a method of the invention for cleaning dishware in a dishwasher.

A further subject of the present invention is the use of a dishwasher detergent of the invention or of one or more copolymers of component Z1) of the dishwasher detergents of the invention for improving the rinse performance of a dishwasher detergent, preferably of a dishwasher detergent of the invention, more preferably in a method of the invention for cleaning dishware in a dishwasher.

A further subject of the present invention is the use of a dishwasher detergent of the invention or of one or more copolymers of component Z1) of the dishwasher detergents of the invention for improving the drying performance of a dishwasher detergent, preferably of a dishwasher detergent of the invention, more preferably in a method of the invention for cleaning dishware in a dishwasher.

The preferred embodiments specified above for the dishwasher detergents of the invention are also valid correspondingly for the method of the invention for cleaning dishware in a dishwasher and also for the inventive use of the dishwasher detergents of the invention or of the one or more copolymers of component Z1) of the dishwasher detergents of the invention as rinse agents in machine dishwashing, for improving the wettability of dishware, for reducing the spotting and filming on dishware, for improving the rinse performance of a dishwasher detergent, preferably of a dishwasher detergent of the invention, and for improving the drying performance of a dishwasher detergent, preferably of a dishwasher detergent of the invention.

The invention is elucidated in more detail below by means of examples, without being limited to these examples. Insofar as not explicitly stated otherwise in the examples, the percentages in the examples are to be understood as percentages by weight (wt %).

### EXAMPLES

Abbreviations used are as follows:

| AAPTAC | [3-(Acryloylamino)propyl]trimethylammonium chloride |
|---|---|
| | (75 wt % active in aqueous solution) |
| AMPS-Na | 2-Acryloylamino-2-methylpropanesulfonic acid, Na salt |
| salt | (50 wt % % active in aqueous solution) |
| DADMAC | Diallyldimethylammonium chloride |
| | (65 wt % active in aqueous solution) |
| DMAA | N,N-Dimethylacrylamide |
| | (100% active) |
| MAPTAC | [3-(Methacryloylamino)propyl]trimethylammonium chloride |
| | (50 wt % active in aqueous solution) |
| MESNA | 2-Mercaptoethanesulfonate sodium |
| | (100% active) |
| Meth 1000 | Polyethylene glycol-co-polypropylene glycol methacrylate, |
| | 1000 g/mol, |
| | 4-5 Propylene glycol units |
| | (70 wt % active in aqueous solution) |
| Meth 5000 | Polyethylene glycol-co-polypropylene glycol methacrylate, |
| | 5000 g/mol, |
| | 4-5 Propylene glycol units |
| | (50 wt % active in aqueous solution) |
| MS-Na | Maleic acid, Na salt |
| salt | (100% active) |
| NIPAM | N-Isopropylacrylamide |
| | (100% active) |
| NVP | N-Vinylpyrrolidone |
| | (100% active) |
| VA-44 | 2,2′-Azobis[2-(2-imidazolin-2-yl)propane] dihydrochloride |
| | (100% active) |
| V-PEG | Polyethylene glycol vinyloxybutyl ether, 1100 g/mol |
| 1100 | (100% active) |
| V-PEG | Polyethylene glycol vinyloxybutyl ether, 5000 g/mol |
| 5000 | (100% active) |

Preparation of the Copolymers

General Protocol for Preparing the Copolymers:

A multineck flask fitted with a KPG stirrer, reflux condenser, and N₂ connection is used to dissolve the specified amounts of chemicals (apart from the initiator) in the specified amount of distilled water under nitrogen (5 liters/hour) for the examples specified in table 1 for preparing copolymers of component Z1). It should be borne in mind that some of the substances used for preparing the copolymers of component Z1) are employed in aqueous form (see the details of the substances used for preparing the copolymers of component Z1)). The distilled water specified in table 1 is added in addition to the water introduced by way of these substances. In the case of acidic monomers, they are neutralized beforehand with base, such as alkali metal carbonate, as for example potassium carbonate. The aqueous solution is subsequently purged with nitrogen for 30 minutes and heated to 60° C. if using VA-44 as initiator or to 80° C. if using Na₂S₂O₈ as initiator. In the next step, the amount of initiator (VA-44 or Na₂S₂O₈) specified in table 1 is dissolved in 10 g of distilled water and metered in over a period of 90 minutes. After the end of metering, stirring is continued for a further hour at an internal temperature of 60° C. if using VA-44 as initiator or at an internal temperature of 80° C. if using Na₂S₂O₈ as initiator. The conversion in the reaction is checked by a subsequent analysis of the solids, and any unconverted monomers, optionally by slight addition of a 10 wt % aqueous solution of the initiator already employed beforehand, are reacted until complete conversion is achieved. Thereafter the reaction mixture is cooled to room temperature (20-23° C.).

Table 1 lists synthesis examples of copolymers of component Z1) of the dishwasher detergents of the invention

TABLE 1
Substances used in preparing the copolymers

| Co- | V-PEG | V-PEG | Meth | Meth | | | | | |
|---|---|---|---|---|---|---|---|---|---|
| polymer | 1100 | 5000 | 1000 | 5000 | AAPTAC | NIPAM | DMAA | DADMAC | MAPTAC |
| # | [mmol] | [mmol] | [mmol] | [mmol] | [mmol] | [mmol] | [mmol] | [mmol] | [mmol] |
| 1 | — | 4.816 | — | — | — | — | 22.899 | — | 61.294 |
| 2 | — | 4.816 | — | — | — | 20.060 | — | — | 61.294 |
| 3 | — | 6.558 | — | — | — | 14.758 | — | — | 25.777 |
| 4 | — | 4.816 | — | — | — | — | 91.395 | — | 30.760 |
| 5 | — | 4.816 | — | — | — | — | 91.395 | — | 30.760 |
| 6 | — | 4.816 | — | — | — | 80.064 | — | — | 30.760 |
| 7 | — | 4.816 | — | — | — | — | 57.198 | — | 46.163 |
| 8 | — | 4.816 | — | — | — | — | 22.899 | 83.755 | — |
| 9 | — | 4.816 | — | — | — | 50.000 | — | — | 46.000 |
| 10 | — | 4.816 | — | — | — | 80.064 | — | — | 30.760 |
| 11 | 29.809 | — | — | — | — | 14.758 | — | — | 25.777 |
| 12 | 29.809 | — | — | — | — | 14.758 | — | — | 25.777 |
| 13 | — | — | — | 8.750 | 30.328 | 55.232 | — | — | — |
| 14 | — | — | 34.370 | — | 30.328 | 55.232 | — | — | — |
| 15 | — | — | 49.994 | — | 27.670 | 14.758 | — | — | — |
| 16 | — | — | — | 10.000 | 28.034 | — | — | — | — |
| 17 | — | — | — | 6.794 | 27.670 | 14.758 | — | — | — |
| | Co- | | AMPS— | MS— | Na-Hypo- | | | | dist. |
| | polymer | NVP | Na salt | Na salt | phosphite | MESNA | VA-44 | Na₂S₂O₈ | H₂O |
| | # | [mmol] | [mmol] | [mmol] | [g] | [g] | [g] | [g] | [g] |
| | 1 | — | — | — | — | — | 1.560 | — | 136.000 |
| | 2 | — | — | — | — | — | 1.560 | — | 136.000 |
| | 3 | — | — | — | 0.120 | — | 1.560 | — | 146.000 |
| | 4 | — | — | — | 0.120 | — | 1.560 | — | 149.450 |
| | 5 | — | — | 1.090 | — | — | 1.560 | — | 149.450 |
| | 6 | — | — | — | 0.120 | — | 1.560 | — | 144.860 |
| | 7 | — | — | — | — | — | 1.560 | — | 139.500 |
| | 8 | — | — | — | — | — | 1.560 | — | 142.250 |
| | 9 | — | — | — | — | — | 1.560 | — | 697.500 |
| | 10 | — | — | — | — | — | 1.560 | — | 724.300 |
| | 11 | — | — | — | 0.120 | — | 1.560 | — | 80.000 |
| | 12 | — | — | — | — | — | 1.560 | — | 149.500 |
| | 13 | 56.235 | — | — | — | 0.180 | 1.560 | — | 131.670 |
| | 14 | 140.543 | — | — | — | 0.540 | 1.560 | — | 160.700 |
| | 15 | — | — | — | — | 0.180 | 1.560 | — | 138.780 |
| | 16 | — | 9.989 | — | — | 0.180 | 1.560 | — | 105.000 |
| | 17 | — | — | — | — | 0.180 | — | 1.150 | 162.790 |

The amounts specified in table 1 are based on the active substance

TABLE 1a
relative amounts according to table 1

| Co- | Total amount | Structural | | | |
|---|---|---|---|---|---|
| poly- | of monomers | units | Structural | Structural | Structural |
| mer | used | (A) | units (B) | units (C) | units (D) |
| # | [mmol] | [mol %] | [mol %] | [mol %] | [mol %] |
| 1 | 89.009 | 68.9 | 5.4 | 25.7 | — |
| 2 | 86.170 | 71.1 | 5.6 | 23.3 | — |
| 3 | 47.093 | 54.7 | 13.9 | 31.3 | — |
| 4 | 126.971 | 24.2 | 3.8 | 72.0 | — |
| 5 | 128.061 | 24.0 | 3.8 | 71.4 | 0.9 |
| 6 | 115.640 | 26.6 | 4.2 | 69.2 | — |
| 7 | 108.177 | 42.7 | 4.5 | 52.9 | — |
| 8 | 111.470 | 75.1 | 4.3 | 20.5 | — |
| 9 | 100.816 | 45.6 | 4.8 | 49.6 | — |
| 10 | 115.640 | 26.6 | 4.2 | 69.2 | — |
| 11 | 70.344 | 36.6 | 42.4 | 21.0 | — |
| 12 | 70.344 | 36.6 | 42.4 | 21.0 | — |
| 13 | 150.545 | 20.1 | 5.8 | 74.0 | — |
| 14 | 260.473 | 11.6 | 13.2 | 75.2 | — |
| 15 | 92.422 | 29.9 | 54.1 | 16.0 | — |
| 16 | 48.023 | 58.4 | 20.8 | 20.8 | — |
| 17 | 49.222 | 56.2 | 13.8 | 30.0 | — |

TABLE 2
Measured weight-average molecular weights M_{w}

| Copolymer | Measured weight-average |
|---|---|
| # | molecular weight M_{w} [g/mol] |
| 1 | 42 261 |
| 2 | 33 497 |
| 3 | 42 667 |
| 5 | 57 227 |
| 6 | 35 849 |
| 7 | 102 330 |
| 8 | 10 934 |
| 9 | 91 934 |
| 10 | 118 920 |

### Example 1: Rinse Performance of Dishwasher Detergents

An investigation was made of the rinse performance of the inventive formulations F2-F6. Tested as a comparative example was the rinse performance of formulation F1, which contained only fatty alcohol alkoxylate as rinse surfactant.

Test Conditions:
Dishwasher: Miele G 1222 SC GSL
Test ware (8 groups): 6 drinking glasses (higher quality)
   6 drinking glasses (lower quality)
   3 polypropylene bowls
   3 melamine plates
   3 butter dishes+4 knives (stainless steel; lower quality)
   4 knives (stainless steel; higher quality)
   3 porcelain plates (higher quality)
   3 porcelain plates (lower quality)
Wash program: program 4, R=2 without prewash
   main wash at 50° C.
   rinsing at 65° C.
Water hardness: 21° dH [German hardness]
Water softening: none
Detergent metering: 18 g, added to the metering chamber before start of test
Soiling: 100 g of frozen soiling, added immediately after opening of the metering chamber
Rinse aid: none
Cleaning cycles: 4

All of the items of ware apart from the polypropylene bowls were treated once with demineralized water, Neodisher A 8, citric acid, and demineralized water again.

Assessment:

Assessment of the test ware was begun no earlier than 30 minutes after the door of the dishwasher had been opened after the end of the wash. In each test, an assessment was made of washes 2-4. The assessment was made in each case in accordance with the following scoring:

Rinse Effects Considered in the Visual Scoring:
Spots spots of different size and intensity
Contact points spots resulting from points of contact between ware and components of the dishwasher
Streaks rinsing streaks
Filming continuous film spread uniformly over the test ware
Structural filming scattered, broken film
Solid residues solid powdery or crystalline residues
Grease residues grease drops or formation of a greasy film
Iridescence opalescence, iridescence

Visual Scoring:
10 Perfect
9 Perfect to just visible
8 Just visible
7 Just visible to visible
6 Visible
5 Visible to nuisance
4 Nuisance
3 Nuisance to unacceptable
2 Unacceptable
1 Absolutely unacceptable

The combination of the eight rinse effects set out above results in a score of 1-10 according to the above visual scoring for each item of ware, with a score of 1 representing the worst performance and a score of 10 being the best performance. For each of the above-listed eight test ware groups, the average score for all items of ware in a particular materials group was formed for each wash, after which the sum total of all the materials groups was formed for each wash, and lastly the average was determined for all three washes 2-4 assessed. The resulting average score was used as the total rinse performance for the purpose of comparing the various formulations F1-F6. This leads to a theoretical maximum with the best rinse performance of 80.0 and to a theoretical minimum with the worst rinse performance of 8.0.

The results are shown in table A hereinafter.

### Example 2: Drying Performance of Dishwasher Detergents

An investigation was made into the drying performance of the inventive formulations F2-F6. As a comparative example, the drying performance of formulation F1, containing only fatty alcohol alkoxylate, was tested.

Test Conditions:
Dishwasher: Bosch SMS86
Test ware: 10 starter knives
   10 starter forks
   10 starter spoons
   10 coffee spoons
   2 vegetable spoons
   12 drinking glasses
   10 porcelain cups
   25 porcelain plates
   3 SAN plates
   3 polypropylene plates
   6 polypropylene bowls
Wash program: Eco 50 Variospeed Plus without prewash
   main wash at 50° C.
   rinsing at 65° C.
   drying phase at 70° C.
Water hardness: 21° dH [German hardness]
Water softening: none
Detergent metering: 18 g, added to the tablet collection tray immediately after opening the metering chamber
Soiling: 100 g of frozen soiling, added immediately after opening of the metering chamber
Rinse aid: none
Cleaning cycles: 4

All the articles were treated once with demineralized water, Neodisher A 8, citric acid, and demineralized water again.

Assessment:

Assessment of the test ware was begun 30 minutes after the end of the wash. During this time, the door of the dishwasher remained closed. In each test, an assessment was made of washes 2-4. The assessment was made in each case under illumination of 1000-1500 lux.

In a set order and with a set time limit, a count was made of the number of adhering residual water drops for each item of test ware. Depending on the number of drops counted, the scoring for each item of test ware is as follows:

Scoring:

| | |
|---|---|
| 0 | dry, no water drops |
| 1 | 1 water drop |
| 2 | 2 water drops |
| 3 | 3 water drops |
| 4 | 4 water drops |
| 5 | 5 water drops |
| 6 | more than 5 water drops |

In this assessment scheme, a score of 0 represents the best performance and a score of 6 the worst performance for each item of test ware. For each wash 2, 3 and 4, the sum total of the scores of all the items of test ware was formed. For comparison of the various formulations F1-F6, the average score of all sum totals of the washes 2-4 was averaged in each case. This leads to a theoretical maximum with the poorest drying performance of 606, and a theoretical minimum with the best drying performance of 0.

The results are shown in table A hereinafter.

Compositions:

The compositions of the formulations F1-F6 and also the values for the rinse performance and for the drying performance are specified in table A below.

TABLE A
Compositions, rinse performance, and drying performance for
formulations F1-F6

| | F1 | F2 | F3 | F4 | F5 | F6 |
|---|---|---|---|---|---|---|
| Component | wt %*⁾ | wt %*⁾ | wt %*⁾ | wt %*⁾ | wt %*⁾ | wt %*⁾ |
| Trisodium citrate | 30.0 | 30.0 | 30.0 | 30.0 | 30.0 | 30.0 |
| dihydrate | | | | | | |
| Sodium carbonate | 20.0 | 20.0 | 20.0 | 20.0 | 20.0 | 20.0 |
| Sodium silicate | 2.0 | 2.0 | 2.0 | 2.0 | 2.0 | 2.0 |
| MGDA—Na₃ | 15.0 | 15.0 | 15.0 | 15.0 | 15.0 | 15.0 |
| Polycarboxylate | 10.0 | 10.0 | 10.0 | 10.0 | 10.0 | 10.0 |
| Sodium percarbonate | 9.0 | 9.0 | 9.0 | 9.0 | 9.0 | 9.0 |
| TAED | 2.0 | 2.0 | 2.0 | 2.0 | 2.0 | 2.0 |
| HEDP | 0.9 | 0.9 | 0.9 | 0.9 | 0.9 | 0.9 |
| Protease | 0.5 | 0.5 | 0.5 | 0.5 | 0.5 | 0.5 |
| Amylase | 0.5 | 0.5 | 0.5 | 0.5 | 0.5 | 0.5 |
| C_{12/15} Oxo-process | 3.5 | 3.5 | 3.5 | 3.5 | 3.5 | 3.5 |
| alcohol alkoxylate | | | | | | |
| Copolymer 1 | — | 0.1 | — | — | — | — |
| Copolymer 2 | — | — | 0.1 | — | — | — |
| Copolymer 3 | — | — | — | 0.1 | — | — |
| Copolymer 4 | — | — | — | — | 0.1 | — |
| Copolymer 5 | — | — | — | — | — | 0.1 |
| Water | ad 100 | ad 100 | ad 100 | ad 100 | ad 100 | ad 100 |
| 2 Sodium sulfate | 2.4**⁾ | 1.9**⁾ | 1.9**⁾ | 1.9**⁾ | 1.9**⁾ | 1.9**⁾ |
| Overall rinse | 25.9 | 28.8 | 29.5 | 29.1 | 31.1 | 30.1 |
| performance | | | | | | |
| Drying performance | 225 | 111 | 103 | 128 | 101 | 107 |

*⁾The ingredients are added according to their active substance content in wt %.
**⁾Sodium sulfate is added as a filler for a constant mass balance of the dishwasher detergent, without function and without influence on the performance of the dishwasher detergent.

From the results in table A above it is apparent that the use of the inventive dishwasher detergents F2-F6 leads to advantageous values for the rinse performance and for the drying performance, in comparison to the use of the comparative formulation F1.

Furthermore, the inventive dishwasher detergents F2-F6 in the above example exhibit very good cleaning performance.

1. A dishwasher detergent comprising
Z1) at least one copolymer containing
a) 0.1 to 99.9 mol % of at least one cationic structural unit (A) and
b) 0.1 to 99.9 mol % of at least one macromonomeric structural unit (B),
wherein the at least one cationic structural unit (A) is represented by the following formulae (I) and/or (II): 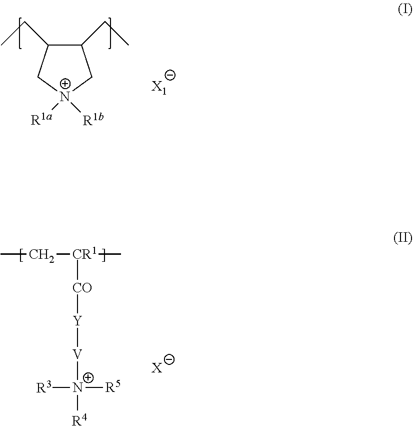
R¹ and R^{1a} are each identical or different and independently of one another are each hydrogen and/or a methyl radical,
R^{1b}, R³, R⁴ and R⁵ are each identical or different and independently of one another are each represented by hydrogen, an aliphatic hydrocarbon radical having 1 to 20 carbon atoms, a cycloaliphatic hydrocarbon radical having 5 to 20 carbon atoms, an aryl radical having 6 to 14 carbon atoms and/or polyethylene glycol (PEG),
Y is identical or different and is represented by oxygen, NH and/or NR³,
V is identical or different and is represented by —(CH₂)ₓ—, 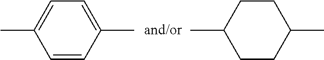
x is identical or different and is represented by an integer from 1 to 6,
X and X₁ are each identical or different and independently of one another are each represented by a halogen atom, C₁ to C₄ alkyl sulfate and/or C₁ to C₄ alkylsulfonate,
and the at least one macromonomeric structural unit (B) is represented by the formula (III): 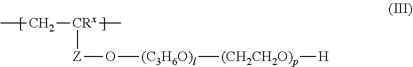
in which
R^{x} is identical or different and is represented by H and/or methyl,
Z is identical or different and is represented by C═O and/or O(CH₂)₄,
l is on molar average a number from 0 to 7, and
p is on molar average a number from 1 to 150,
and
Z2) at least one enzyme.

2. The dishwasher detergent as claimed in claim 1, wherein the at least one cationic structural unit (A) of the at least one copolymers of component Z1) represents the polymerization product of at least one monomer species selected from the group consisting of [2-(acryloyloxy)ethyl]trimethylammonium chloride, [2-(acryloylamino)-ethyl]trimethylammonium chloride, [2-(acryloyloxy)ethyl]trimethylammonium methosulfate, [2-(methacryloyloxy)ethyl]trimethylammonium chloride and methosulfate, [3-(acryloylamino)propyl]trimethylammonium chloride, [3-(methacryloylamino)propyl]trimethylammonium chloride and diallyldimethylammonium chloride (DADMAC).

3. The dishwasher detergent as claimed in claim 1, wherein the at least one macromonomeric structural unit (B) of the formula (III) of the at least one copolymer of component Z1) represents the polymerization product of at least one monomer species selected from the group consisting of polyethylene glycol vinyloxybutyl ether, polyethylene glycol-co-polypropylene glycol vinyloxybutyl ether (in which l is on molar average a number from 1 to 7), polyethylene glycol (meth)acrylate and polyethylene glycol-co-polypropylene glycol (meth)acrylate (in which l is on molar average a number from 1 to 7).

4. The dishwasher detergent as claimed in claim 1, wherein, in the at least one macromonomeric structural unit (B) of the formula (III) of the at least one copolymer of component Z1),
i) R^{x} is H, l is 0, and p is on molar average a number from 1 to 150 if Z is O(CH₂)₄ or
ii) R^{x} is identical or different and is represented by H and/or methyl, l is on molar average a number from 1 to 7, and p is on molar average a number from 1 to 150 if Z is C═O.

5. The dishwasher detergent as claimed in claim 1, wherein the at least one copolymer of component Z1) comprises not only the structural units (A) and (B) but also at least one structural unit (C) which differ from the structural units (A) and (B), the at least one copolymer containing
0.1 to 99.8 mol % of the at least one structural unit (A), 0.1 to 99.8 mol % of the at least one structural unit (B), and 0.1 to 99.8 mol % of the at least one structural unit (C).

6. The dishwasher detergent as claimed in claim 5, wherein the at least one structural unit (C) of the at least one copolymer of component Z1) represents the polymerization product of at least one monomer species selected from the group consisting of noncationic acrylamides, noncationic methacrylamides, and N-vinyl-substituted lactams having 5 to 7 ring atoms.

7. The dishwasher detergent as claimed in claim 5, wherein the at least one structural unit (C) of the at least one copolymer of component Z1) is selected from the group consisting of the polymerization product of at least one N-vinyl-substituted lactam having 5 to 7 ring atoms and structural units of the following formulae (IV) and/or (V): 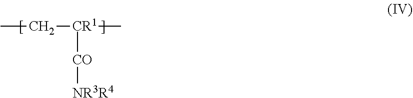
in which
R¹ is identical or different and is hydrogen and/or methyl, and
R³ and R⁴ are each identical or different and independently of one another are each represented by hydrogen, an aliphatic hydrocarbon radical having 1 to 20 carbon atoms, a cycloaliphatic hydrocarbon radical having 5 to 20 carbon atoms, an aryl radical having 6 to 14 carbon atoms, an alkylaryl radical having 7 to 14 carbon atoms, a branched or unbranched C₁-C₅ monohydroxyalkyl group and/or polyethylene glycol (PEG) 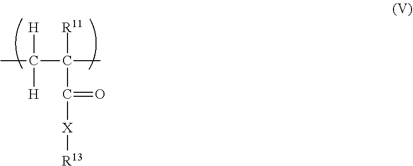
in which
R¹¹ is identical or different and is represented by H and/or methyl;
X is identical or different and is represented by NH—(CₙH₂ₙ) where n=1, 2, 3 or 4; and
R¹³ is identical or different and is represented by OH, N(CH₃)₂, SO₃H, PO₃H₂, O—PO₃H₂ and/or para-substituted C₆H₄—SO₃H.

8. The dishwasher detergent as claimed in claim 1, wherein the at least one structural unit (C) of the at least one copolymer of component Z1) is selected from the group consisting of the structural units of the formula (IV).

9. The dishwasher detergent as claimed in claim 1, wherein the at least one structural unit (C) of the at least one copolymer of component Z1) represents the polymerization product of at least one monomer species selected from the group consisting of acrylamide, methacrylamide, N-methylacrylamide, N,N-dimethylacrylamide, N-ethylacrylamide, N-cyclohexylacrylamide, N-benzylacrylamide, N-methylolacrylamide, N-isopropylacrylamide, and N-tert-butylacrylamide.

10. The dishwasher detergent as claimed in claim 5, wherein the at least one copolymer of component Z1) comprise not only the structural units (A), (B), and (C) but also at least one structural unit (D) which differs from the structural units (A), (B), and (C), the at least one copolymer comprises
0.1 to 99.7 mol % of the at least one structural unit (A), 0.1 to 99.7 mol % of the at least one structural unit (B), 0.1 to 99.7 mol % of the at least one structural unit (C), and 0.1 to 99.7 mol % of the at least one structural unit (D).

11. The dishwasher detergent as claimed in claim 10, wherein the at least one copolymer of component Z1) comprises at least one structural unit (D) selected from the qroup consistinq of the structural units of the following formulae (IX) and/or (X): 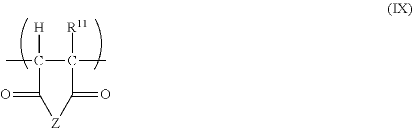
in which
R¹¹ is identical or different and is represented by H and/or methyl;
Z is identical or different and is represented by O and/or NH; 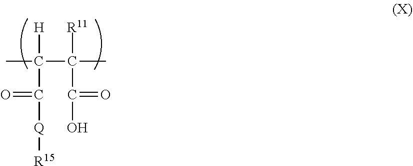
in which
R¹¹ is identical or different and is represented by H and/or methyl;
Q is identical or different and is represented by O and/or NH; and
R¹⁵ is identical or different and is represented by H, (CₙH₂ₙ)—SO₃H where n=0, 1, 2, 3 or 4; (CₙH₂ₙ)—OH where n=0, 1, 2, 3 or 4; (CₙH₂ₙ)—PO₃H₂ where n=0, 1, 2, 3 or 4; (CₙH₂ₙ)—OPO₃H₂ where n=0, 1, 2, 3 or 4; (C₆H₄)—SO₃H; (C₆H₄)—PO₃H₂; (C₆H₄)—OPO₃H₂ and/or (CₘH₂ₘ)ₑ—O-(A′O)ᵤ—R¹⁶ where m=0, 1, 2, 3 or 4, e=0, 1, 2, 3 or 4, A′=C_{x′}H_{2x′} where x′=2, 3, 4 or 5, u=an integer from 1 to 350, and R¹⁶ is identical or different and is represented by an unbranched or branched C₁-C₄ alkyl group.

12. The dishwasher detergent as claimed in claim 10, wherein the structural units (A), (B), and optionally (C) and (D) of the at least one copolymer of component Z1) is present in random, blockwise, alternating or gradientlike distribution in the copolymer.

13. The dishwasher detergent as claimed in claim 1, wherein the weight-average molecular weight M_{w} of the at least one copolymer of component Z1) is from 10 000 to 250 000 g/mol.

14. The dishwasher detergent as claimed in claim 1, wherein it comprises the at least one copolymer of component Z1) in an amount from 0.0005 to 10 wt %, based in each case on the total weight of the dishwasher detergent.

15. The dishwasher detergent as claimed in claim 1, wherein the at least one enzyme of component Z2) is selected from the group consisting of proteases, amylases, lipases, hemicellulases, cellulases, perhydrolases, and oxidoreductases.

16. The dishwasher detergent as claimed in claim 1, wherein it comprises the at least one enzyme of component Z2) in an amount from 1×10⁻⁶ to 5 wt %, based in each case on the total weight of the dishwasher detergent.

17. The dishwasher detergent as claimed in claim 1, wherein it comprises not only the at least one copolymer of component Z1) and the at least one enzyme of component Z2) but also at least one further substance selected from the group consisting of the components Z3), Z4), Z5) and Z6):
Z3) at least one builder as component Z3),
Z4) a bleaching system as component Z4),
Z5) at least one surfactant as component Z5),
Z6) at least one further additive,
and the pH of the dishwasher detergent at 20° C. from 8 to 14, measured as a 10 wt % solution of the liquid or solid dishwasher detergent in water.

18. The dishwasher detergent as claimed in claim 17, wherein the at least one surfactant of component Z5) is selected from the group of nonionic surfactants.

19. The dishwasher detergent as claimed in claim 17, wherein the at least one surfactant of component Z5) is selected from the group consisting of fatty alcohol alkoxylates, endgroup-capped fatty alcohol alkoxylates, ethylene oxide propylene oxide block copolymers, N-acylglucamides, and epoxy-capped poly(oxalkylated) alcohols.

20. The dishwasher detergent as claimed in claim 17, wherein it contains
Z1) 0.0005 to 10 wt % of component Z1),
Z2) 1×10⁻⁶ to 5 wt % of component Z2),
Z3) 2 to 50 wt % of component Z3),
Z4) 1 to 40 wt % of component Z4),
Z5) 0.10 to 15 wt % of component Z5),
Z6) 0 to 10 wt % of component Z6)
based in each case on the total weight of the dishwasher detergent.

21. The dishwasher detergent as claimed in claim 1, wherein it contains no phosphate-based builders.

22. The dishwasher detergent as claimed in claim 1, wherein it is solid at 20° C. and is in the form of a tablet.

23. A method for cleaning dishware in a dishwasher, wherein soiled dishware is treated in a dishwasher with an aqueous alkaline composition comprising a dishwasher detergent as claimed in claim 1.

24. The method as claimed in claim 23, wherein the pH of the aqueous alkaline composition is 8 or more.

25.-28. (canceled)
